(19) United States
(12) Patent Application Publication
(10) Pub. No.: US 2026/0317133 A1
(43) Pub. Date: Oct. 15, 2026

(54) SLOW DROP FLOOR JACK

(71) Applicant: Mac's Performance Manufacturing LLC, Mooresville, NC (US)

(72) Inventor: Andrew McCarthy, Mooresville, NC (US)

(21) Appl. No.: 19/644,198

(22) Filed: Apr. 10, 2026

Related U.S. Application Data
(60) Provisional application No. 63/787,196, filed on Apr. 11, 2025.

(51) Int. Cl. B66F 5/04; F16K 1/38; F16K 1/54

(52) U.S. Cl. CPC B66F 5/04; F16K 1/38; F16K 1/54

(57) ABSTRACT

A method, apparatus, and system for high performance jacks and hydraulic valves is disclosed. A hydraulic valve includes a valve housing, a valve seat, and a plunger. The valve seat comprises an orifice region having a constant width of a first orifice width. The plunger comprises a first plunger region and a second plunger region configured to be inserted into the orifice region of the valve seat. The first plunger region extends in an axial direction from an end of the plunger and comprises an increasing width from a first plunger width at the end of the plunger to a second plunger width less than the first orifice width. The second plunger region is adjacent to the first plunger region and extends in the axial direction with a constant width of the second plunger width. A jack includes a base, a handle, a load arm, and a hydraulic valve.

### CROSS REFERENCE TO RELATED APPLICATION

This application claims priority under 35 U.S.C. § 119 to U.S. Provisional Application No. 63/787,196, filed on Apr. 11, 2025, in the United States Patent and Trademark Office, the disclosure of which is incorporated by reference herein in its entirety.

### BACKGROUND

The following relates generally to aerospace and auto racing, and more specifically to high performance jacks and hydraulic valves. Recent development efforts resulted in a high-performance racing jack design and construction method. A racing floor jack is pictured above. Racing jacks can be unsafe when the jack is released, and the weight is allowed to fall to the ground. Therefore, there is a need in the art for a jack that causes the weight it is holding to come to the ground more gradually.

### SUMMARY

The present disclosure includes a hydraulic valve improved over conventional needle valves and a jack, which features an orifice region (with a shoulder region) on the valve seat having a tightly controlled diameter or width distance from a plunger. This design is aimed at solving the challenging problem of achieving fine-grained flow rate and drop rate control in traditional valve-based jacks, where conventional linear needle valves require an operator to carefully modulate their response to prevent the load from falling rapidly. The inventive concept offers the advantage of a non-linear orifice, providing in operation a stage of valve opening (e.g., corresponding to a 90-degree handle rotation) where the load arm on the jack will drop at a constant speed, regardless of how quickly the handle is opened; further, the jack is configured to lower the load arm even without a load thereon. This allows for a comfortable operating range and ensures a specific, desired drop response every time, leading to safer operation and ease of use, improving technologies in the field of aerospace and auto racing.

An apparatus, system, and method for high performance jacks and hydraulic valves are described. One or more aspects of the apparatus, system, and method comprises a hydraulic valve that includes a valve housing; a valve seat comprising an orifice region having a constant width of a first orifice width; and a plunger comprising a first plunger region and a second plunger region configured to be inserted into the orifice region of the valve seat, where the first plunger region extends in an axial direction from an end of the plunger and comprises an increasing width from a first plunger width at the end of the plunger to a second plunger width less than the first orifice width, and where the second plunger region is adjacent to the first plunger region and extends in the axial direction with a constant width of the second plunger width.

An apparatus, system, and method for high performance jacks and hydraulic valves are described. One or more aspects of the apparatus, system, and method comprises a jack that includes a base; a handle; a load arm; and a hydraulic valve comprising: a valve housing; a valve seat comprising an orifice region having a constant width of a first orifice width; and a plunger comprising a first plunger region and a second plunger region configured to be inserted into the orifice region of the valve seat, where the first plunger region extends in an axial direction from an end of the plunger and comprises an increasing width from a first plunger width at the end of the plunger to a second plunger width less than the first orifice width, and where the second plunger region is adjacent to the first plunger region and extends in the axial direction with a constant width of the second plunger width.

An apparatus, system, and method for high performance jacks and hydraulic valves are described. One or more aspects of the apparatus, system, and method comprises a jack that includes a base; a handle; a load arm; and a hydraulic valve controllable by the handle to lower the load arm, where: within a first range of positions of the handle, the hydraulic valve is configured to enable the load arm to be lowered at an increasing rate with respect to a change in a position of the handle; within a second range of positions of the handle adjacent to the first range, the hydraulic valve is configured to enable the load arm to be lowered at a constant rate with respect to the change in the position of the handle; and within a third range of positions of the handle adjacent to the second range, the hydraulic valve is configured to enable the load arm to be lowered at an increasing rate with respect to the change in the position of the handle.

### BRIEF DESCRIPTION OF THE DRAWINGS

FIG. 1 shows an example of a jack in use according to aspects of the present disclosure.

FIG. 2 shows an example of a jack in operation according to aspects of the present disclosure.

FIG. 3 shows an example of a jack according to aspects of the present disclosure.

FIG. 4 shows an example of a hydraulic valve disposed in a jack according to aspects of the present disclosure.

FIG. 5 shows an example of a hydraulic valve according to aspects of the present disclosure.

FIG. 6 shows an example of a hydraulic valve with multiple plunger regions according to aspects of the present disclosure.

FIGS. 7-8 show examples of a hydraulic valve with a non-linear plunger according to aspects of the present disclosure.

FIG. 9 shows an example of a hydraulic valve with a non-linear plunger in comparison with conventional valves according to aspects of the present disclosure.

FIG. 10 shows an example of a hydraulic valve with an orifice region according to aspects of the present disclosure.

FIG. 11 shows an example of a hydraulic valve that is closed according to aspects of the present disclosure.

FIG. 12 shows an example of a hydraulic valve that is orificed and allowing a slow flow of hydraulic fluid according to aspects of the present disclosure.

FIG. 13 shows an example of a hydraulic valve open and allowing a full flow of hydraulic fluid according to aspects of the present disclosure.

FIG. 14 shows an example of a hydraulic valve that is closed according to aspects of the present disclosure.

FIG. 15 shows an example of a hydraulic valve allowing a slow flow of hydraulic fluid according to aspects of the present disclosure.

FIG. 16 shows an example of a hydraulic valve open and allowing a full flow of hydraulic fluid according to aspects of the present disclosure.

FIG. 17 shows an example of a jack including a non-linear valve according to aspects of the present disclosure.

FIG. 18 shows an example of a bottle jack according to aspects of the present disclosure.

FIG. 19 shows an example of a hydraulic high lift jack according to aspects of the present disclosure.

FIG. 20 shows an example of a hydraulic scissor lift table according to aspects of the present disclosure.

FIG. 21 shows an example of A Jack configured for multi-stage load-arm lowering in comparison with conventional jacks according to aspects of the present disclosure.

### DETAILED DESCRIPTION

The present disclosure includes a hydraulic valve improved over conventional needle valves and a jack, which features an orifice region (with a shoulder region) on the valve seat having a tightly controlled diameter or width distance from a plunger. This design is aimed at solving the challenging problem of achieving fine-grained flow rate and drop rate control in traditional valve-based jacks, where conventional linear needle valves require an operator to carefully modulate their response to prevent the load from falling rapidly. The inventive concept offers the advantage of a non-linear orifice, providing in operation a stage of valve opening (e.g., corresponding to a 90-degree handle rotation) where the load arm on the jack will drop at a constant speed, regardless of how quickly the handle is opened; further, the jack is configured to lower the load arm even without a load thereon. This allows for a comfortable operating range and ensures a specific, desired drop response every time, leading to safer operation and ease of use, improving technologies in the field of aerospace and auto racing.

Conventional jacks using a valve may include a geometric cone with a large altitude or an increasing flow linear orifice to control fluid flow through an orifice as the valve opens, sometimes due to cost or simplicity concerns. However, conventional jacks lack a precision achieved in controlling the drop speed or the rate at which the loading arm lowers. Further, uncontrolled fluid flow rates and loading arm drop/lowering rates may cause damage of the load, or hurt people, or both; to prevent such risks typically requires the user to modulate their response very tightly to achieve a desired drop rate, leading to inconvenience and unpleasant user experience.

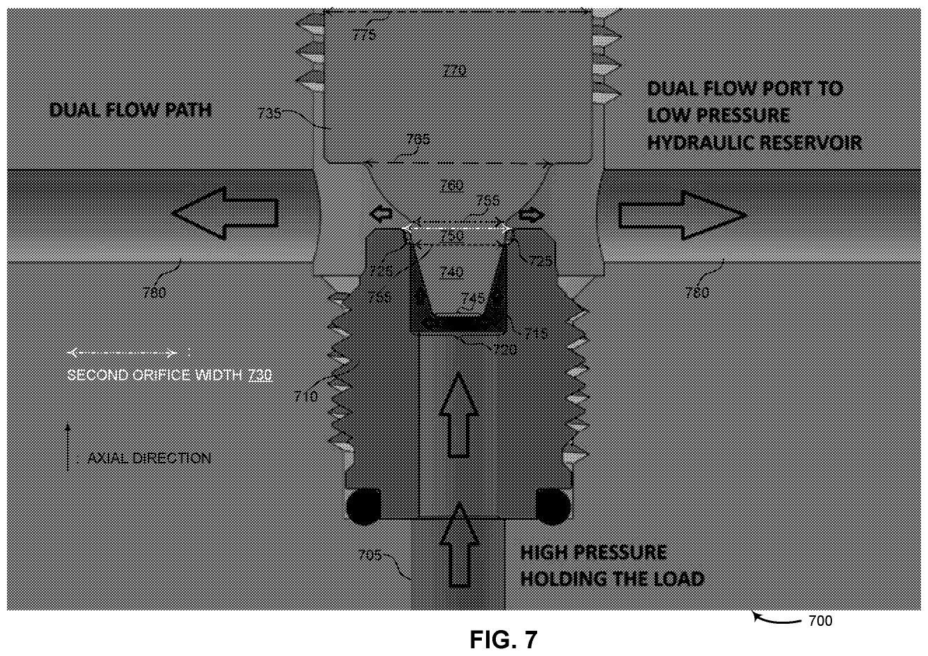

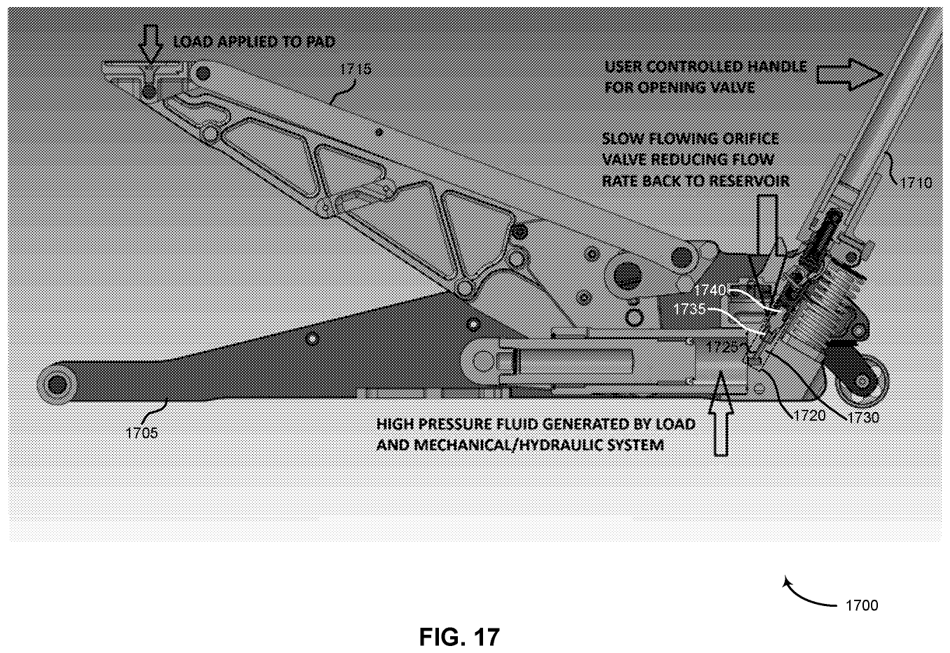

The present invention improves upon and is advantageous over conventional valve-based, flow-operated jacks by achieving finer control over the flow rate and load dropping speed. For example, during one stage of operation, the flow rate remains steady or flat as the valve opens, meaning the flow rate does not increase. In some embodiments, the load drops at a constant speed for a range of handle positions (e.g. caused by a range of rotation angles of the handle). To achieve the finer control, a hydraulic valve including multiple plunger regions extending axially is provided, where a first plunger region comprises an increasing width and a second plunger region adjacent to the first region comprises a constant width, giving rise to a controlled, non-linear orifice. Overall, the orifice valve design such as hydraulic valve 700 of FIG. 7 features non-linearity in an orifice. The hydraulic valve, when used in a jack such as one embodied in FIG. 17, slows down the fall rate of a load on a hydraulic jack to a safer speed to reduce the chance of damaging the load or hurting people, allowing easier use of a hydraulic jack by individual user or users and improving user experiences.

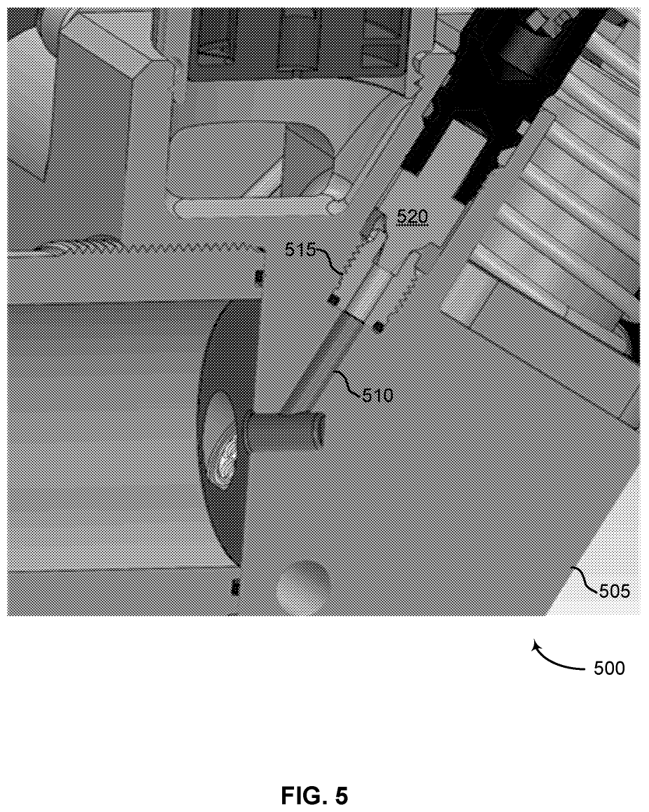

In some embodiments, a hydraulic valve is provided. The hydraulic valve includes, inter alia, a plunger including multiple regions of varying or constant widths. When the plunger is operated with an orifice region and a shoulder region of the valve seat, the hydraulic valve is configured to maintain a fine-grained control of a hydraulic flow, where for a range of positions (e.g. corresponding to a stage of turning a handle), the hydraulic flow runs at a constant speed. Aspects about the hydraulic valve is described in more details with reference to FIGS. 7-16 and 5-6.

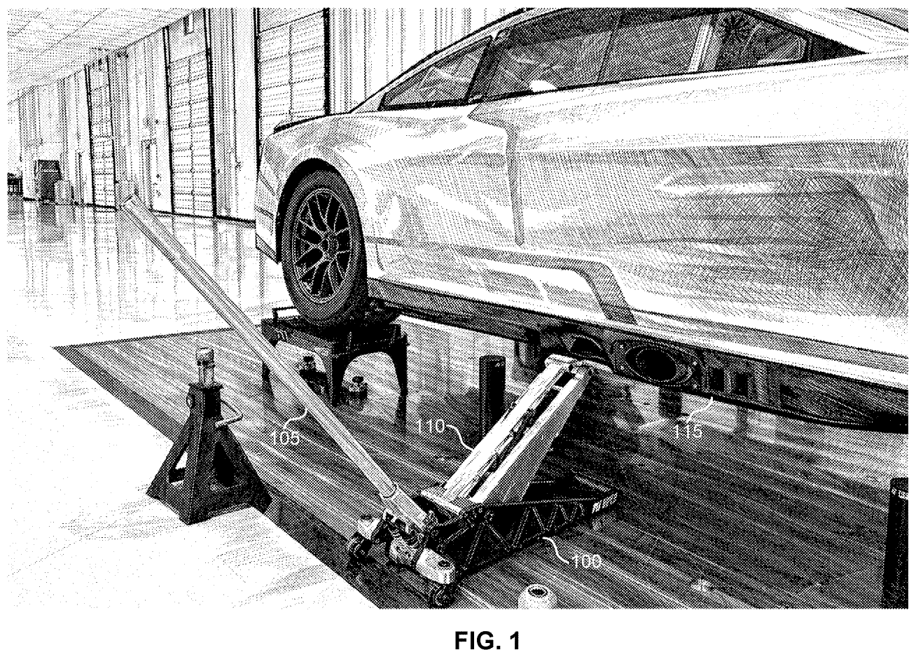

In some embodiments, a jack is provided. The jack includes, inter alia, a hydraulic valve configured to enable a multi-stage lowering of a load arm of the jack, for example by turning a handle of the jack. Particularly, in one of the stages (corresponding to a range of the handle positions), the load arm drops at a constant rate, corresponding to the constant hydraulic flow rate. Moreover, the jack is configured to lower its load arm even without load on the load arm or on a pad region of the load arm. Aspects about the jack is described in more details with reference to FIGS. 17-21 and 1-4.

The term “non-linear” a design for a hydraulic valve with multiple regions respectively corresponding to multiple widths, or respectively corresponding to different rates of width change, in some cases constant. For example, the first plunger region 740 extends in an axial direction from an end of the plunger 735 and comprises an increasing width from the first plunger width 745 at the end of the plunger to a second plunger width 755 (as indicated by the boundary of first plunger region 900), and the second plunger region 750 is adjacent to the first plunger region 740 and extends in the axial direction with a constant width of the second plunger width 755 (as indicated by the boundary of second plunger region 905); for example, the third plunger region 760 is adjacent to the second plunger region 750 and extends in the axial direction with an increasing width from the second plunger width 755 to a third plunger width 765 (as indicated by the boundary of third plunger region 910), and the fourth plunger region 770 is adjacent to the third plunger region 760 and extends in the axial direction with a constant width of a fourth plunger width 775 greater than the third plunger width 765 (as indicated by the boundary of fourth plunger region 915). Details of such examples are described with reference to FIGS. 7-9.

The term “multi-stage loading arm lowering” refers to a feature of the present disclosure where within different ranges of handle positions (e.g. by user turning the handle), the load arm drops at different rates or ranges of rates, where particularly corresponding to a certain range of handle positions, the load arm drops at a constant rate or speed corresponding to a constant rate or speed of the hydraulic fluid flow. For example, in some embodiments, within a first range of positions of the handle 2105, the hydraulic valve is configured to enable the load arm to be lowered at an increasing rate (first rate of load arm lowering 2110) with respect to a change in a position of the handle; within a second range of positions of the handle 2115 adjacent to the first range (first range of positions of the handle 2105), the hydraulic valve is configured to enable the load arm to be lowered at a constant rate (second rate of load arm lowering 2120, where flow rate occurs but does not increase as the valve opens; in other words, this valve's flow rate is fixed for a certain amount of handle rotation before rapidly increasing to much higher flow) with respect to the change in the position of the handle; and within a third range of positions of the handle 2125, the hydraulic valve is configured to enable the load arm to be lowered at an increasing rate (third rate of load arm lowering 2130) with respect to the change in the position of the handle. Further, in some examples, the jack is configured to enable the load arm to be lowered with no load on the load arm.

### Jack and Hydraulic Valve

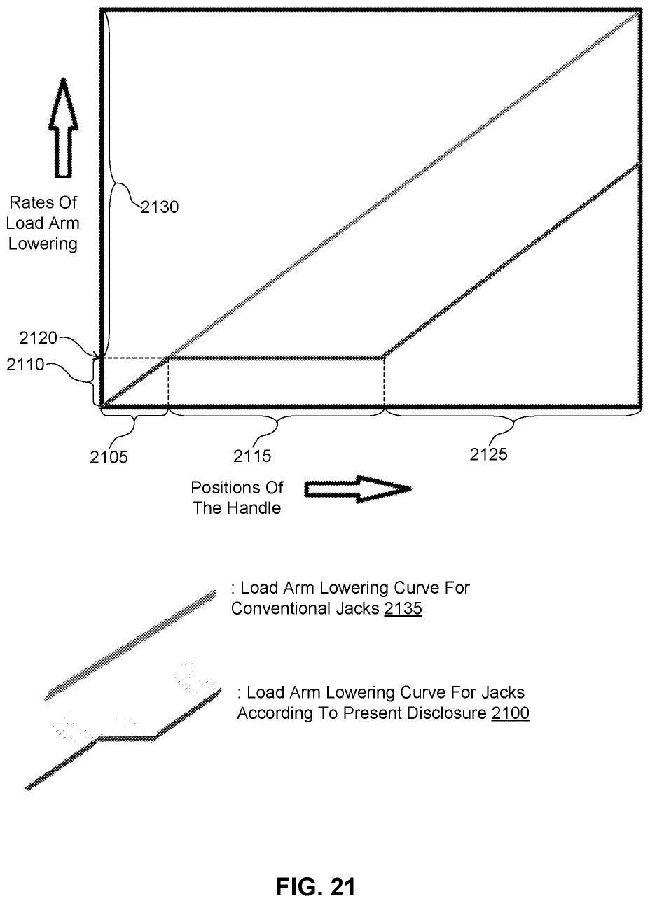

FIG. 1 shows an example of a jack in use according to aspects of the present disclosure. In FIG. 1, The example shown includes base 100, handle 105, load arm 110, and load 115. In the example, as depicted, load 115 is a car. It is therefore very beneficial to have the jack configured to perform a multi-stage lowering, thereby achieving fine-grained control of flow and drop speed, reducing safety concerns (e.g. for the driver), offering an advantage over existing designs, and solving the technical problem of achieving fine-grained flow rate and drop rate control in hydraulic jacks. More details on the multi-stage load lowering are described with reference e.g. to FIG. 21.

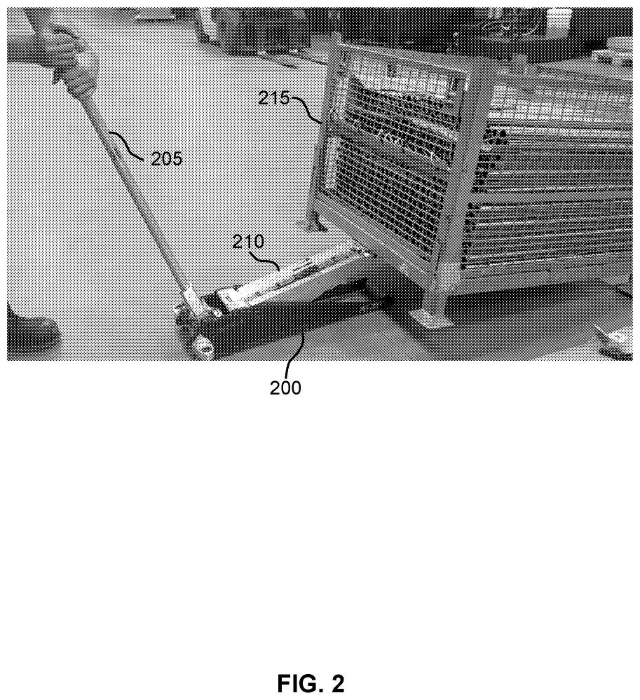

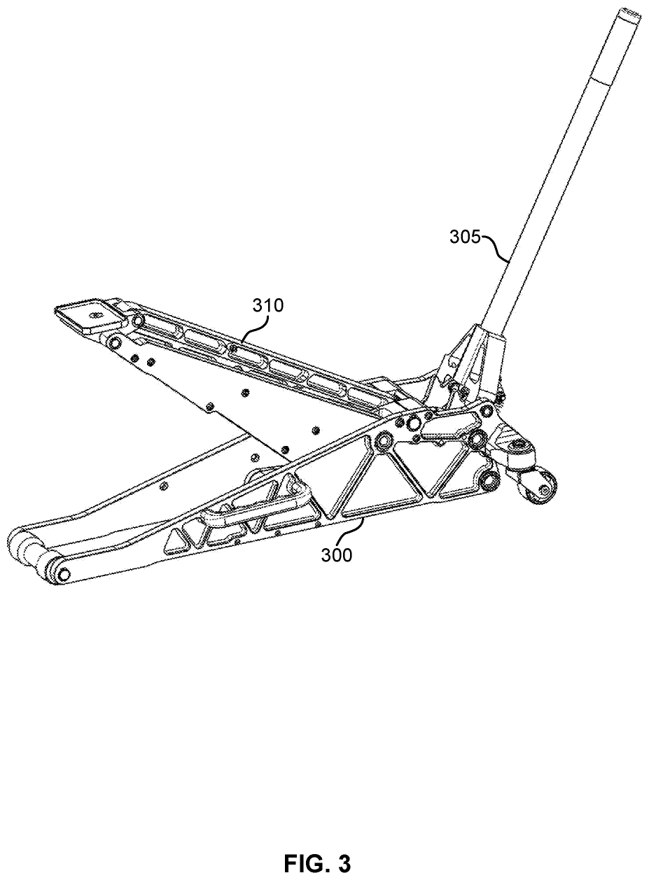

User may turn the handle 105 to operate the jack. Base 100, handle 105, and load arm 110 are examples of, or include aspects of, corresponding elements in FIGS. 2 and 3.

FIG. 2 shows an example of a jack in operation according to aspects of the present disclosure. The example shown includes base 200, handle 205, load arm 210, and load 215.

FIG. 2 depicts a jack, more particularly a safe-release floor jack, in operation. Base 200 is an example of, or includes aspects of, the corresponding element described with reference to FIGS. 3 and 17. Handle 205 is an example of, or includes aspects of, the corresponding element described with reference to FIGS. 3 and 17. Load arm 210 is an example of, or includes aspects of, the corresponding element described with reference to FIGS. 1, 3 and 17. In FIG. 2, load arm 210 is connected to a pad holding the load 215. User the handle 205 to drop the load arm 210.

One inventive aspect is creating a device (e.g. a jack according to the present disclosure) that slows a drop speed (e.g. for load arm 210) to a desired level when there is a load (e.g. load 215) on the jack but also allows for a quick drop of the pad and load arm 210 when there is no load (e.g. absent the load 215) on the pad connected to load arm 210. Unlike the present disclosure, conventional jacks using a simple orifice would not allow the load arm 210 to drop quickly when there is no load (e.g. absent the load 215) on the pad, usually leading to suboptimal user experiences. More details are described with reference to FIG. 21.

FIG. 3 shows an example of a jack according to aspects of the present disclosure. The example shown includes base 300, handle 305, and load arm 310. The jack depicted in FIG. 3 is an example of, or includes aspects of, the jack or safe-release floor jack of FIGS. 1-2.

Base 300 is an example of, or includes aspects of, the corresponding element described with reference to FIGS. 1-2 and 17. Handle 305 is an example of, or includes aspects of, the corresponding element described with reference to FIGS. 1-2 and 17. Load arm 310 is an example of, or includes aspects of, the corresponding element described with reference to FIGS. 1-2 and 17.

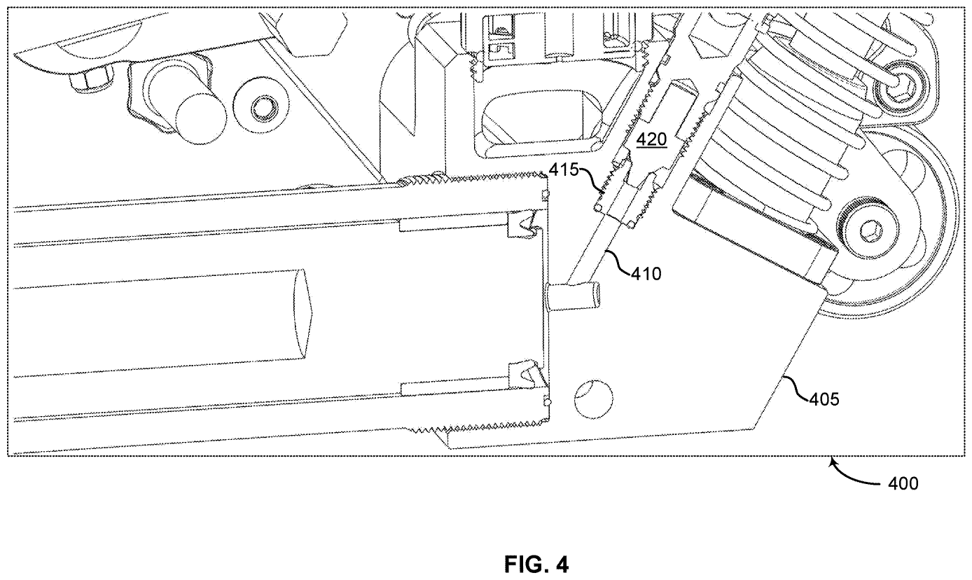

FIG. 4 shows an example 400 of a hydraulic valve disposed in a jack according to aspects of the present disclosure. Example 400 includes aspects of is an example of, or includes aspects of, the corresponding element described with reference to FIG. 5 (e.g. hydraulic valve 500), 6-7, and 17. In some embodiments, example 400 includes valve housing 405, inflow channel 410, valve seat 415, and plunger 420.

Valve housing 405 is an example of, or includes aspects of, the corresponding element described with reference to FIGS. 5, 6, 9, and 17. Inflow channel 410 is an example of, or includes aspects of, the corresponding element described with reference to FIGS. 5, 6, 7, and 17. In FIG. 4, a side of a pressure relief valve (e.g. example 400 or hydraulic valve 500) corresponding to the inflow channel 410 is the high-pressure side up against the valve seat 415 with an O-ring at the bottom of inflow channel 410 (the O-ring e.g. depicted in FIG. 5). Valve seat 415 is an example of, or includes aspects of, the corresponding element described with reference to FIGS. 5, 7, and 10-17. Plunger 420 is an example of, or includes aspects of, the corresponding element described with reference to FIGS. 5, 6, 7, and 10-17.

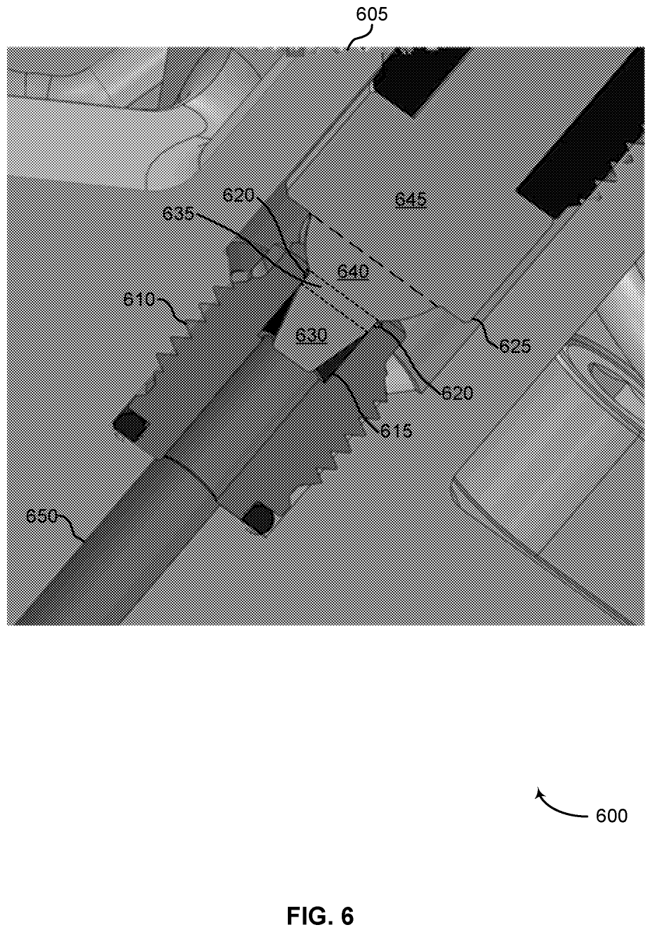

FIG. 5 shows an example of a hydraulic valve 500 according to aspects of the present disclosure. Hydraulic valve 500 is an example of or includes aspects of (e.g. as a closer view of) example 400. Hydraulic valve 500 is an example of, or includes aspects of, the corresponding element described with reference to FIGS. 6, 7, and 17. In some embodiments, hydraulic valve 500 includes valve housing 505, inflow channel 510, valve seat 515, and plunger 520.

Valve housing 505 is an example of, or includes aspects of, the corresponding element described with reference to FIGS. 4, 6, 9, and 17. Inflow channel 510 is an example of, or includes aspects of, the corresponding element described with reference to FIGS. 4, 6, 7, and 17. In FIG. 5, a side of the pressure relief valve (e.g. hydraulic valve 500) corresponding to the inflow channel 510 is the high-pressure side up against the valve seat 515 with an O-ring at the bottom of inflow channel 510. Valve seat 515 is an example of, or includes aspects of, the corresponding element described with reference to FIGS. 4, 7, and 10-17. Plunger 520 is an example of, or includes aspects of, the corresponding element described with reference to FIGS. 4, 6, 7, and 10-17.

FIG. 6 shows an example of a hydraulic valve 600 with multiple plunger regions according to aspects of the present disclosure.

Hydraulic valve 600 is an example of, or includes aspects of, the corresponding element described with reference to FIGS. 5, 7, and 17. According to some aspects, hydraulic valve 600 is controllable by the handle to lower the load arm According to some aspects, within a first range of positions of the handle, hydraulic valve 600 is configured to enable the load arm to be lowered at an increasing rate with respect to a change in a position of the handle. In some examples, within a second range of positions of the handle adjacent to the first range of positions of the handle, hydraulic valve 600 is configured to enable the load arm to be lowered at a constant rate with respect to the change in the position of the handle. In some examples, within a third range of positions of the handle adjacent to the second range of positions of the handle, hydraulic valve 600 is configured to enable the load arm to be lowered at an increasing rate with respect to the change in the position of the handle.

In some embodiments, hydraulic valve 600 includes valve housing 605, valve seat 610, plunger 625, and inflow channel 650. Valve housing 605 is an example of, or includes aspects of, the corresponding element described with reference to FIGS. 5, 9, and 17.

In sone aspects, valve seat 610 includes orifice region 615 and shoulder region 620. According to some aspects, valve seat 610 comprises an orifice region 615 having a constant width of a first orifice width. In some embodiments, the valve seat 610 includes a shoulder region 620 adjacent to the orifice region 615 and extending in the axial direction, where the shoulder region 620 includes an increasing width from the first orifice width to a second orifice width greater than the first orifice width.

Orifice region 615 is an example of, or includes aspects of, the corresponding element described with reference to FIGS. 7, and 10-16. Shoulder region 620 is an example of, or includes aspects of, the corresponding element described with reference to FIGS. 7, and 14-16. In some embodiments, the valve seat 610 includes the shoulder region 620 adjacent to the orifice region 615 and extending in the axial direction, where the shoulder region 620 includes an increasing width from the first orifice width to a second orifice width greater than the first orifice width. For more details, see FIG. 7 and description thereof.

Plunger 625 is an example of, or includes aspects of, the corresponding element described with reference to FIGS. 5, 7, and 10-17. In one aspect, plunger 625 includes first plunger region 630, second plunger region 635, third plunger region 640, and fourth plunger region 645.

First plunger region 630 is an example of, or includes aspects of, the corresponding element described with reference to FIG. 7. Second plunger region 635 is an example of, or includes aspects of, the corresponding element described with reference to FIG. 7. According to some aspects, plunger 625 comprises a first plunger region 630 and a second plunger region 635 configured to be inserted into the orifice region 615 of the valve seat 610, wherein the first plunger region 630 extends in an axial direction from an end of the plunger 625 and comprises an increasing width from a first plunger width at the end of the plunger 625 to a second plunger width less than the first orifice width, and wherein the second plunger region 635 is adjacent to the first plunger region 630 and extends in the axial direction with a constant width of the second plunger width. For more details, see FIG. 7 and description thereof.

Third plunger region 640 is an example of, or includes aspects of, the corresponding element described with reference to FIG. 7. Fourth plunger region 645 is an example of, or includes aspects of, the corresponding element described with reference to FIG. 7. In some embodiments, the plunger 625 further includes a third plunger region 640 and a fourth plunger region 645, where the third plunger region 640 is adjacent to the second plunger region 635 and extends in the axial direction with an increasing width from the second plunger width to a third plunger width that is greater than the first orifice width, and where the fourth plunger region 645 is adjacent to the third plunger region 640 and extends in the axial direction with a constant width of a fourth plunger width greater than the third plunger width. For more details, see FIG. 7 and description thereof.

In some embodiments of the present disclosure according to FIG. 6, The plunger 625 comes from the top of a jack and is controlled by the user by rotating the handle (e.g. handle 305) in a manner similar to conventional floor jacks. In some embodiments, is a section of valve seat 610 is cut to an appropriate size and the cylinder of the plunger 625, just before it tapers, is cut to a matching size (e.g. sizing matching the cut of the section of valve seat 610) to give an orifice, e.g. orifice region 615 and/or shoulder region 620 for the hydraulic fluid to flow through as the valve is opened. Once the user rotates the handle (e.g. handle 305) far enough, opening the hydraulic valve 600 past the orifice (e.g. orifice region 615 and/or the shoulder region 620), the taper allows the fluid to flow more rapidly under all conditions; particularly, the jack is configured to enable the load arm (e.g. load arm 310) to be lowered with no load on the load arm (e.g. 310) thanks to designs as depicted in FIGS. 6-7. The sizing of the area of the orifice (e.g. orifice region 615 and/or shoulder region 620) is important for making the system work and in some embodiments, the area of the orifice is a small area to be controlled.

Inflow channel 650 is an example of, or includes aspects of, the corresponding element described with reference to FIGS. 5, 7, and 17. According to some aspects, inflow channel 650 is configured to allow hydraulic fluid to flow through the valve seat 610 into the orifice region. According to some aspects hydraulic valve 600 further includes an outflow channel configured to allow hydraulic fluid to flow out of the valve housing. In some embodiments, hydraulic valve 600 further includes an additional hydraulic valve downstream of the hydraulic valve 600 with respect to hydraulic fluid (e.g. direction of the fluid flow), wherein the additional hydraulic valve is configured to decrease a rate of the hydraulic fluid.

Hydraulic Valve with Non-Linear Plunger Regions

FIG. 7 shows an example of a hydraulic valve 700 with a non-linear plunger (plunger 735) according to aspects of the present disclosure. In some embodiments, hydraulic valve 700 includes inflow channel 705, valve seat 710, plunger 735, and outflow channel 780; valve seat 710 includes orifice region 715 and shoulder region 725; and plunger 735 includes first plunger region 740, second plunger region 750, third plunger region 760, and fourth plunger region 770. Plunger 735 is configured to be inserted into the orifice region 715 of the valve seat 710.

In some embodiments, orifice region 715 comprises first orifice width 720. First plunger region 740 extends in an axial direction (shown in FIG. 7) from an end of the plunger 735. First plunger region 740 comprises an increasing width from a first plunger width 745 at the end of the plunger 735 to a second plunger width 755. The second plunger width 755 is less than the first orifice width 720. Second plunger region 750 is adjacent to the first plunger region 740 and extends in the axial direction with a constant width of the second plunger width 755. FIG. 7 depicts both the upper and lower boundaries of the second plunger region 750 having the second plunger width 755.

In some embodiments, third plunger region 760 is adjacent to the second plunger region 750 and extends in the axial direction with an increasing width from the second plunger width 755 (depicted in FIG. 7 as upper boundary of second plunger region 750) to a third plunger width 765. The third plunger width 765 is greater than the first orifice width 720. The fourth plunger region 770 is adjacent to the third plunger region 760 and extends in the axial direction with a constant width of a fourth plunger width 775. The fourth plunger width 775 is greater than the third plunger width 765.

In some embodiments, shoulder region 725 is adjacent to the orifice region 715 and extends in the axial direction, wherein the shoulder region 725 comprises an increasing width from the first orifice width 720 to a second orifice width 730 greater than the first orifice width 720 (and hence greater than the second plunger width 755 and the first plunger width 745).

In some embodiments, inflow channel 705 is configured to allow hydraulic fluid to flow through the valve seat 710 into the orifice region 715. For example, when a jack containing hydraulic valve 700 is in operation, the hydraulic fluid flows pass inflow channel 705 through the valve seat 710 into the orifice region 715 and past the shoulder region 725, reaching outflow channel 780 that is configured to allow hydraulic fluid to flow out of the valve housing.

Thanks to such a design and embodiments, a jack including and operated based on hydraulic valve 700 is configured to control hydraulic valve 700 by e.g. turning a handle to lower a load arm at various rates corresponding to various positions of the handle, where for a particular range of handle positions, hydraulic valve 700 is configured to enable the load arm to lower at a constant rate with respect to that particular range. That is, the drop or lowering speed is controlled no matter how fast the handle is open and, to some extent, how far the handle is opened (e.g. in terms of angles of rotation). A rate for the load arm lowering corresponds to a rate of the hydraulic flow in some embodiments. By adjusting the length of e.g. first plunger region 740 and/or second plunger region 750, control is enabled on how much rotation of the handle is required to get past the slowed rate of drop/lowering. Further, the jack including and operated based on hydraulic valve 700 is configured to enable the load arm to be lowered even with no load on the load arm. See e.g. description with reference to FIG. 21.

A taper (e.g. first plunger region 740) can also be controlled to determine how quickly or slowly the user can adjust the hydraulic flow after the orifice is no longer in the way, and allows for a more a more controlled increase in the fall rate as the user continues to open the valve with the handle. Overall, the orifice valve design such as hydraulic valve 700 slows down the fall rate of a load on a hydraulic jack to a safer speed to reduce the chance of damaging the load, or hurting people, allowing easier use of a hydraulic jack by individual user or users.

Hydraulic valve 700 and inflow channel 705 are examples of, or include aspects of, the respectively corresponding elements described with reference to FIGS. 5-6, and 17. Outflow channel 780 is an example of, or includes aspects of, the corresponding element described with reference to FIG. 17.

Valve seat 710 is an example of, or includes aspects of, the corresponding element described with reference to FIGS. 5-6, and 10-17. Orifice region 715 is an example of, or includes aspects of, the corresponding element described with reference to FIGS. 5-6, and 10-16. Shoulder region 725 is an example of, or includes aspects of, the corresponding element described with reference to FIGS. 6 and 10-16.

Plunger 735 is an example of, or includes aspects of, the corresponding element described with reference to FIGS. 5-6, and 10-17. The taper (e.g. first plunger region 740) to the plunger 735 allows the user to determine the fall rate once the orifice (e.g. orifice region 715 and/or shoulder region 725) is no longer controlling the flow. Diameters of the valve seat 710 and the plunger 735 need to be very close to each other, but particular sizes of the set are not overly relevant to the design; rather, the sizes are more closely aligned with the load weight.

First plunger region 740, second plunger region 750, third plunger region 760, and fourth plunger region 770 are examples of, or include aspects of, the respectively corresponding elements described with reference to FIG. 6.

In alternative or additional embodiments, the pressure generated by the load in the system (e.g. load on the load arm 1715 described with reference to FIG. 17) is used to apply force to change the size of the orifice (e.g. widths for the orifice region 715 and/or the shoulder region 725), where more pressure generates lower fluid flow and absence of pressure generates normal full flow conditions.

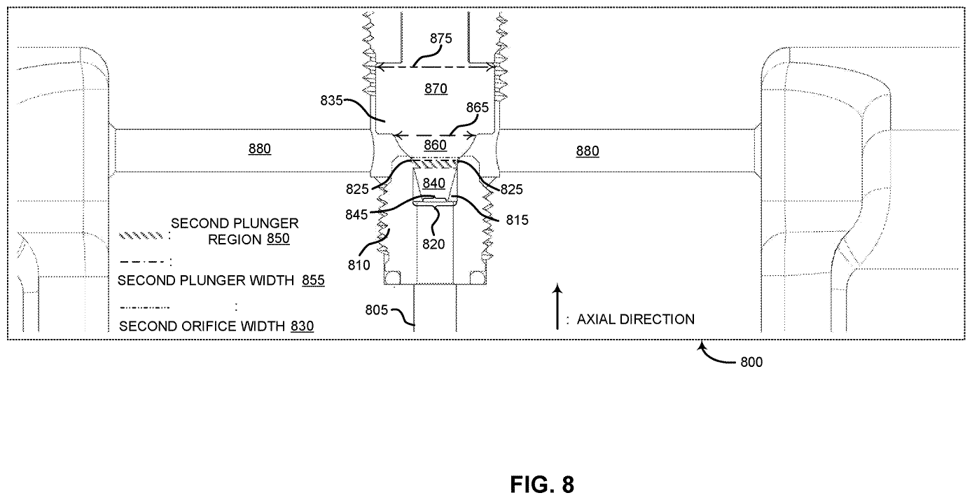

FIG. 8 shows a hydraulic valve 800 with a non-linear plunger (plunger 835) according to aspects of the present disclosure. In some embodiments, hydraulic valve 800 includes inflow channel 805, valve seat 810, plunger 835, and outflow channel 880; valve seat 810 includes orifice region 815 and shoulder region 825; and plunger 835 includes first plunger region 840, second plunger region 850, third plunger region 860, and fourth plunger region 870. Plunger 835 is configured to be inserted into the orifice region 815 of the valve seat 810.

In some embodiments, orifice region 815 comprises first orifice width 820. First plunger region 840 extends in an axial direction (as depicted in FIG. 8) from an end of the plunger 835. First plunger region 840 comprises an increasing width from a first plunger width 845 at the end of the plunger 835 to a second plunger width 855. The second plunger width 855 is less than the first orifice width 820. Second plunger region 850 is adjacent to the first plunger region 840 and extends in the axial direction with a constant width of the second plunger width 855. FIG. 8 depicts both the upper and lower boundaries of the second plunger region 850 having the second plunger width 855.

In some embodiments, third plunger region 860 is adjacent to the second plunger region 850 and extends in the axial direction with an increasing width from the second plunger width 855 (depicted in FIG. 8 as upper boundary of second plunger region 850) to a third plunger width 865. The third plunger width 865 is greater than the first orifice width 820. The fourth plunger region 870 is adjacent to the third plunger region 860 and extends in the axial direction with a constant width of a fourth plunger width 875. The fourth plunger width 875 is greater than the third plunger width 865.

In some embodiments, shoulder region 825 is adjacent to the orifice region 815 and extends in the axial direction, wherein the shoulder region 825 comprises an increasing width from the first orifice width 820 to a second orifice width 830 greater than the first orifice width 820 (and hence greater than the second plunger width 855 and the first plunger width 845).

In some embodiments, inflow channel 805 is configured to allow hydraulic fluid to flow through the valve seat 810 into the orifice region 815. For example, when a jack containing hydraulic valve 800 is in operation, the hydraulic fluid flows pass inflow channel 805 through the valve seat 810 into the orifice region 815 and past the shoulder region 825, reaching outflow channel 880 that is configured to allow hydraulic fluid to flow out of the valve housing.

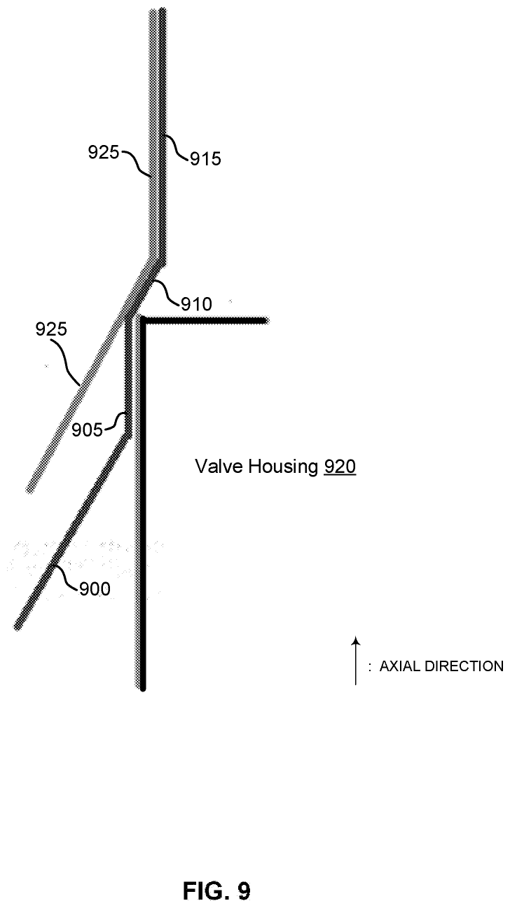

Hydraulic valve 800 is an example of or includes aspects of hydraulic valve 700. Similarly, numbered elements of hydraulic valve 800 (inflow channel 805 through outflow channel 880) are respectively examples of or respectively include aspects of the corresponding elements in FIG. 7 (respectively the inflow channel 705 through the outflow channel 780). Boundaries of first plunger region 840, second plunger region 850, third plunger region 860, and fourth plunger region 870 respectively include aspects of corresponding elements of FIG. 9 (respectively, boundary of first plunger region 900, boundary of second plunger region 905, boundary of third plunger region 910, and boundary of fourth plunger region 915).

FIG. 9 shows an example of a hydraulic valve with a non-linear plunger in comparison with conventional valves according to aspects of the present disclosure. The example shown includes boundary of first plunger region 900, boundary of second plunger region 905, boundary of third plunger region 910, boundary of fourth plunger region 915, valve housing 920, and boundary of a conventional valve 925.

Valve housing 920 is an example of, or includes aspects of, the corresponding element described with reference to FIGS. 5, 6, and 17. In some embodiments, boundary of first plunger region 900 comprises or depicts a boundary of the first plunger region 740, boundary of second plunger region 905 comprises or depicts a boundary of the second plunger region 750, boundary of third plunger region 910 comprises or depicts a boundary of the third plunger region 760, and boundary of fourth plunger region 915 comprises or depicts a boundary of the fourth plunger region 770.

Apparatuses according to the present disclosure, such as the hydraulic valve 700, comprise a valve with a non-linear orifice, where “non-linearity” is a substantive feature referring to a design with multiple regions respectively corresponding to multiple widths, or respectively corresponding to different rates of width change, in some cases constant. For example, the first plunger region 740 extends in an axial direction from an end of the plunger 735 and comprises an increasing width from the first plunger width 745 at the end of the plunger to a second plunger width 755 (as indicated by the boundary of first plunger region 900), and the second plunger region 750 is adjacent to the first plunger region 740 and extends in the axial direction with a constant width of the second plunger width 755 (as indicated by the boundary of second plunger region 905); for example, the third plunger region 760 is adjacent to the second plunger region 750 and extends in the axial direction with an increasing width from the second plunger width 755 to a third plunger width 765 (as indicated by the boundary of third plunger region 910), and the fourth plunger region 770 is adjacent to the third plunger region 760 and extends in the axial direction with a constant width of a fourth plunger width 775 greater than the third plunger width 765 (as indicated by the boundary of fourth plunger region 915).

Boundary of a conventional valve 925 comprises or depicts an aspect of conventional designs in this field, typically comprising a valve with a linear orifice that configured to generate or let through a static flow rate or a continually increasing flow rate (or correspondingly, a rate of lowering the load arm). If a plunger tapers down its length, the conventional valve is typically configured to increase the fluid flow (or its rate) linearly. If the conventional valve comprises a cylinder with no taper, it typically provides a static linear flow.

Non-linearity as embodied e.g. in FIG. 7 and herein distinguishes the present disclosure from pre-existing or conventional designs (e.g. the conventional valves corresponding to the boundary of a conventional valve 925). In particular a step in the cone (e.g. multiple plunger regions, referring to FIG. 7) at the orifice point (e.g. shoulder region 725) of the embodiments of the present disclosure is significantly different from conventional designs. By collaboration or coordination between e.g. orifice region 715, shoulder region 725, first plunger region 740, second plunger region 750, or a combination thereof, an operator or user may simply open the valve and consistently achieving the desired drop, for example achieving a drop/arm-lowering rate-range of handle positions correspondence as depicted and described with reference to FIG. 21.

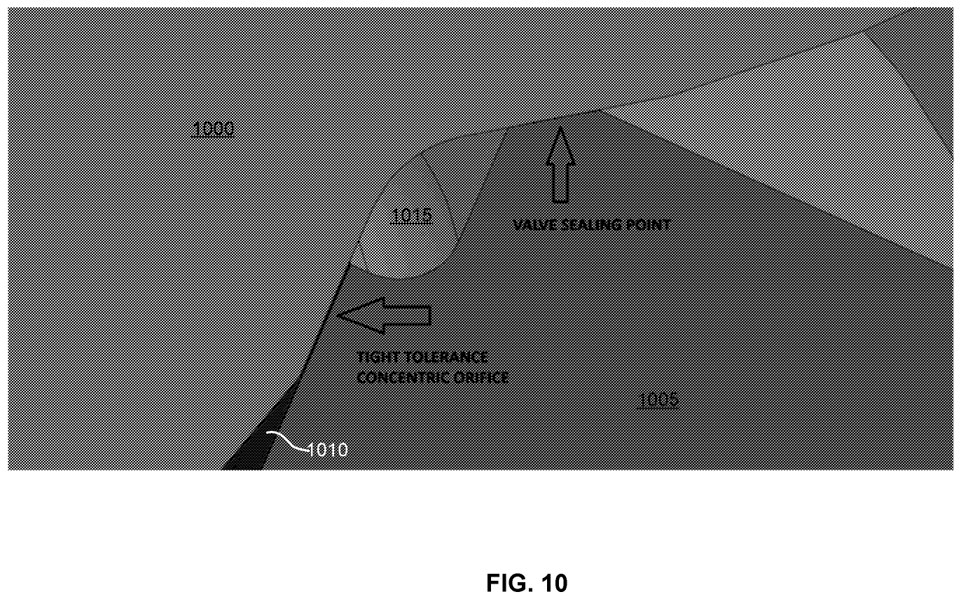

FIG. 10 shows an example of a hydraulic valve with an orifice region 1010 according to aspects of the present disclosure. The example shown includes plunger 1000, valve seat 1005, orifice region 1010, and shoulder region 1015. In some embodiments, valve seat 1005 includes orifice region 1010 and shoulder region 1015.

Plunger 1000 is an example of, or includes aspects of, the corresponding element described with reference to FIGS. 5-7, and 14-17. Valve seat 1005 is an example of, or includes aspects of, the corresponding element described with reference to FIGS. 5, 7, and 14-17. Orifice region 1010 is an example of, or includes aspects of, the corresponding element described with reference to FIGS. 6, 7, and 14-16. Shoulder region 1015 is an example of, or includes aspects of, the corresponding element described with reference to FIGS. 6, 7, and 14-16.

Diameters or widths of the orifice region 1010 and shoulder region 1015 relative to diameters or widths of different regions (e.g. first plunger region 740 and second plunger region 750 with reference to FIG. 7) of plunger 1000 are important for embodiments of the disclosure. This disclosure ensures that the difference between diameters is maintained at the desired size for effectiveness. In some embodiments, the unit (e.g. encompassing the plunger 1000 and the valve seat 1005 including the orifice region 1010 and shoulder region 1015) was effective with a diameter difference of 0.0003″ and requires a diameter difference below around 0.0006″ to maintain effectiveness. A sharp difference of diameters or transition between the two parts (e.g. the plunger 1000 and the valve seat 1005, the latter including the orifice region 1010 and shoulder region 1015) would cause a stark change in a flow rate and/or the drop/lowering/descending rate of the load arm of the jack. In some embodiments, this is a significantly tight tolerance to hold between two parts. Other important factors for the present disclosure include a length of the orifice region (e.g. a length of orifice region 715 in the axial direction, see FIG. 7) and a rate of a taper.

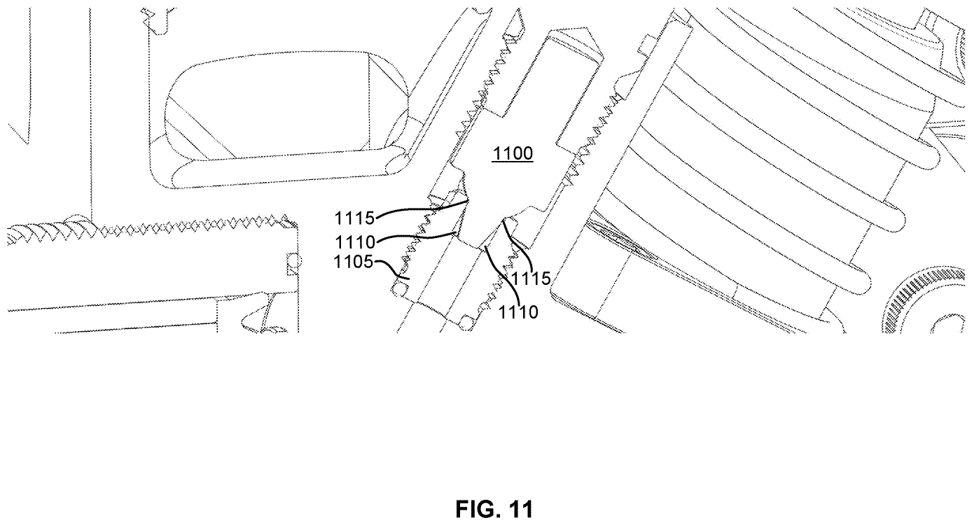

FIG. 11 shows an example of a hydraulic valve that is closed according to aspects of the present disclosure. In FIG. 11, the example shown includes plunger 1100 and valve seat 1105. In some embodiments, valve seat 1105 includes orifice region 1110 and shoulder region 1115.

Plunger 1100 is an example of, or includes aspects of, the corresponding element described with reference to FIGS. 5-7, 10, and 14-17. Valve seat 1105 is an example of, or includes aspects of, the corresponding element described with reference to FIGS. 5, 7, 10, and 14-17. Orifice region 1110 is an example of, or includes aspects of, the corresponding element described with reference to FIGS. 6, 7, 10, and 14-16. Shoulder region 1115 is an example of, or includes aspects of, the corresponding element described with reference to FIGS. 6, 7, and 14-16.

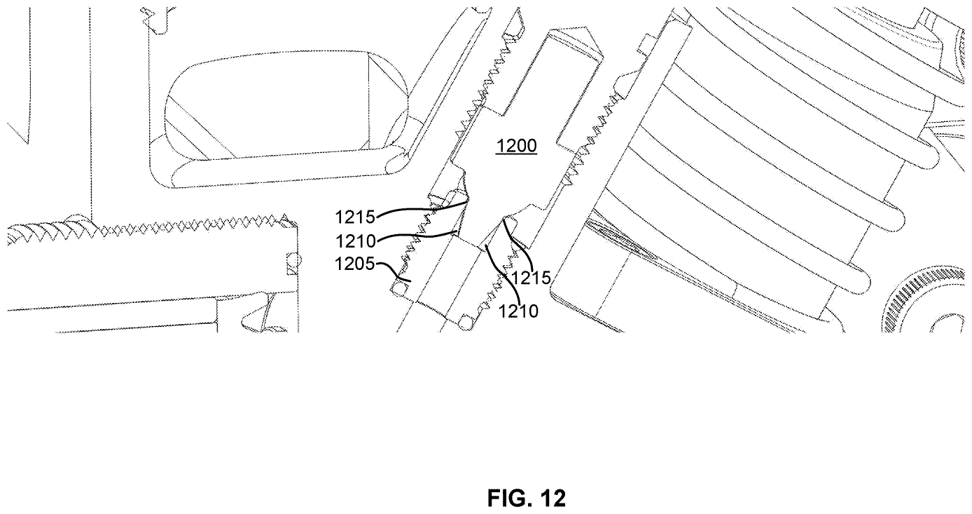

FIG. 12 shows an example of a hydraulic valve that is orificed and allowing a slow flow of hydraulic fluid according to aspects of the present disclosure. In FIG. 12, the example shown includes plunger 1200 and valve seat 1205. In some embodiments, valve seat 1205 includes orifice region 1210 and shoulder region 1215. In FIG. 12, the hydraulic valve is orificed or partially open.

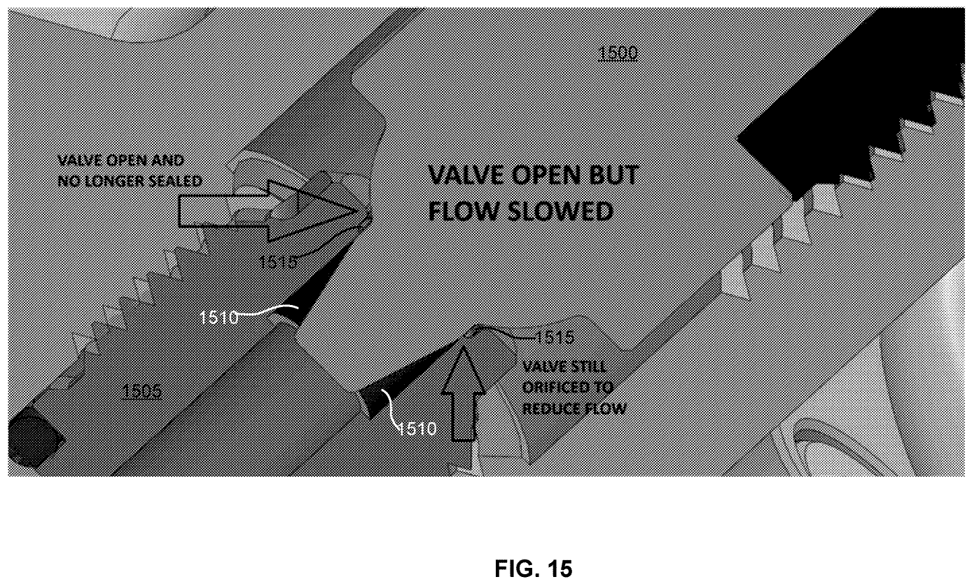

Plunger 1200 is an example of, or includes aspects of, the corresponding element described with reference to FIGS. 5-7, 10, and 14-17. Valve seat 1205 is an example of, or includes aspects of, the corresponding element described with reference to FIGS. 5, 7, 10, and 14-17. Orifice region 1210 is an example of, or includes aspects of, the corresponding element described with reference to FIGS. 6, 7, 10, and 14-16. Shoulder region 1215 is an example of, or includes aspects of, the corresponding element described with reference to FIGS. 6, 7, and 14-16. Some more details are described e.g. with reference to FIG. 15.

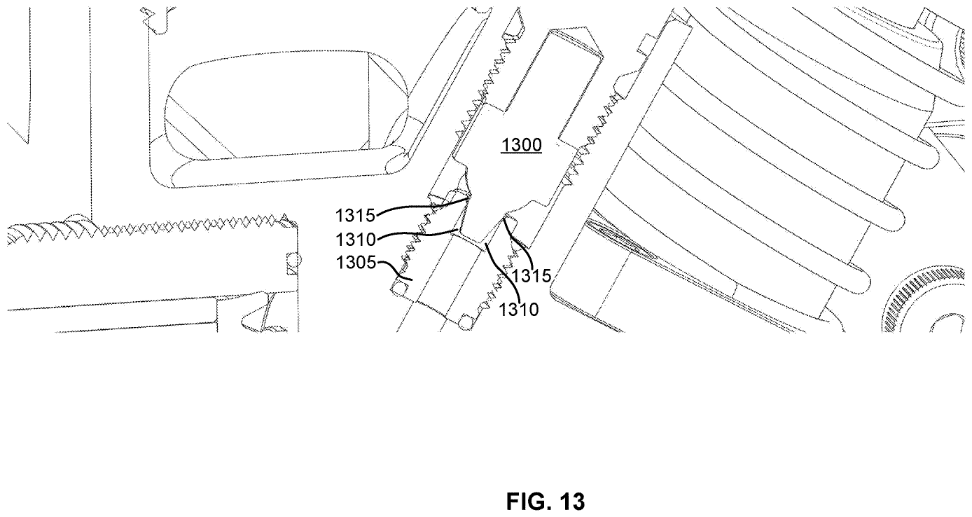

FIG. 13 shows an example of a hydraulic valve that is open and allowing a slow flow of hydraulic fluid according to aspects of the present disclosure. In FIG. 13, the example shown includes plunger 1300 and valve seat 1305. In some embodiments, valve seat 1305 includes orifice region 1310 and shoulder region 1315.

Plunger 1300 is an example of, or includes aspects of, the corresponding element described with reference to FIGS. 5-7, and 10-17. Valve seat 1305 is an example of, or includes aspects of, the corresponding element described with reference to FIGS. 5, 7, and 10-17. Orifice region 1310 is an example of, or includes aspects of, the corresponding element described with reference to FIGS. 6, 7, and 10-16. Shoulder region 1315 is an example of, or includes aspects of, the corresponding element described with reference to FIGS. 6-7, and 14-16.

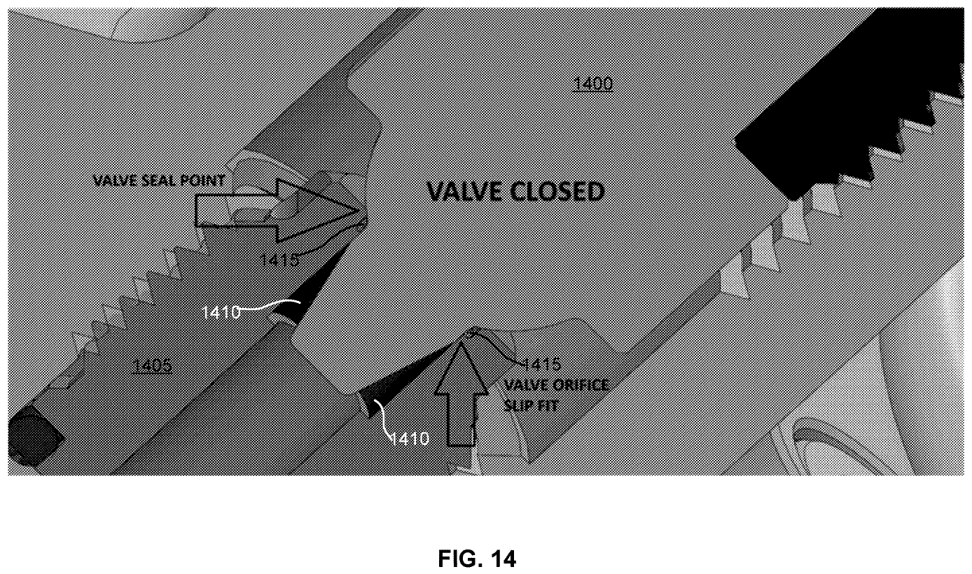

FIGS. 11-13 shows a hydraulic valve in operation (closed→orificed or partially open→open). The operation includes aspects of or is an example of an operation corresponding in FIGS. 14-16.

FIG. 14 shows an example of a hydraulic valve that is closed according to aspects of the present disclosure. The example shown includes plunger 1400 and valve seat 1405. In some embodiments, valve seat 1405 includes orifice region 1410 and shoulder region 1415.

Plunger 1400 is an example of, or includes aspects of, the corresponding element described with reference to FIGS. 5-7, 10-11, and 15-17. Valve seat 1405 is an example of, or includes aspects of, the corresponding element described with reference to FIGS. 5, 7, 10-11, and 15-17. Orifice region 1410 is an example of, or includes aspects of, the corresponding element described with reference to FIGS. 6, 7, 10-11, 15, and 16. Shoulder region 1415 is an example of, or includes aspects of, the corresponding element described with reference to FIGS. 6, 7, 11, 15, and 16.

FIG. 15 shows an example of a hydraulic valve open and allowing a slow flow of hydraulic fluid according to aspects of the present disclosure. The example shown includes plunger 1500 and valve seat 1505. In some embodiments, valve seat 1505 includes orifice region 1510 and shoulder region 1515. In FIG. 15, the hydraulic valve is partially open or orificed.

Plunger 1500 is an example of, or includes aspects of, the corresponding element described with reference to FIGS. 5-7, 10, 14, 16, and 17. Valve seat 1505 is an example of, or includes aspects of, the corresponding element described with reference to FIGS. 5, 7, 10, 14, 16, and 17. Orifice region 1510 is an example of, or includes aspects of, the corresponding element described with reference to FIGS. 6, 7, 10, 14, and 16. Shoulder region 1515 is an example of, or includes aspects of, the corresponding element described with reference to FIGS. 6, 7, 14, and 16.

An important feature of the present disclosure's embodiments is that the cylinder protruding into the taper passes the edge of the orifice as the valve opens, where the valve plunger initially acts as the proper orifice for a small opening, then becomes more full-flowing as the handle is opened further, configuring the jack to enable the load arm to be lowered or dropped with no load on the load arm. For example, second plunger region 750 and/or first plunger region 740 passes shoulder region 725 as the hydraulic valve 700 opens, with reference to FIG. 7. With this feature, some embodiments of the hydraulic valve (e.g. hydraulic valve 700) of the present disclosure are configured to block over 99% of the fluid flow area (e.g. at certain stage of opening the valve) or 99.5% of the fluid path to significantly affect the load drop rate, achieving reasonable outcome (e.g. load arm lowering/dropping rate) for received or intended load(s), exceeding the capability of conventional valves.

Plunger 1500, valve seat 1505, orifice region 1510, shoulder region 1515 or a combination thereof as depicted in FIG. 15 includes aspects of second range of positions of the handle 2115 and second rate of load arm lowering 2120 (a constant rate) described with reference to FIG. 21, highlighting differences from conventional valves. For example, to expand on conventional valves e.g. typical needle valves, while the flow can be controlled reasonably depending on its design (taper angle, size, thread pitch) with such a device it's usually more of a linear rate of increase. Unlike the conventional valves, including a concentric orifice section (e.g. orifice region 715 and/or the shoulder region 725) in embodiments of the present disclosure (e.g. hydraulic valve 700) creates a section of the valve opening process so that the flow rate (and e.g. correspondingly a rate of load arm lowering/drop) is flat (e.g. second rate of load arm lowering 2120) and doesn't change as the user rotates the handle to open the valve. This gives the user a very comfortable range, as they can open the valve before the rate of fall starts to increase.

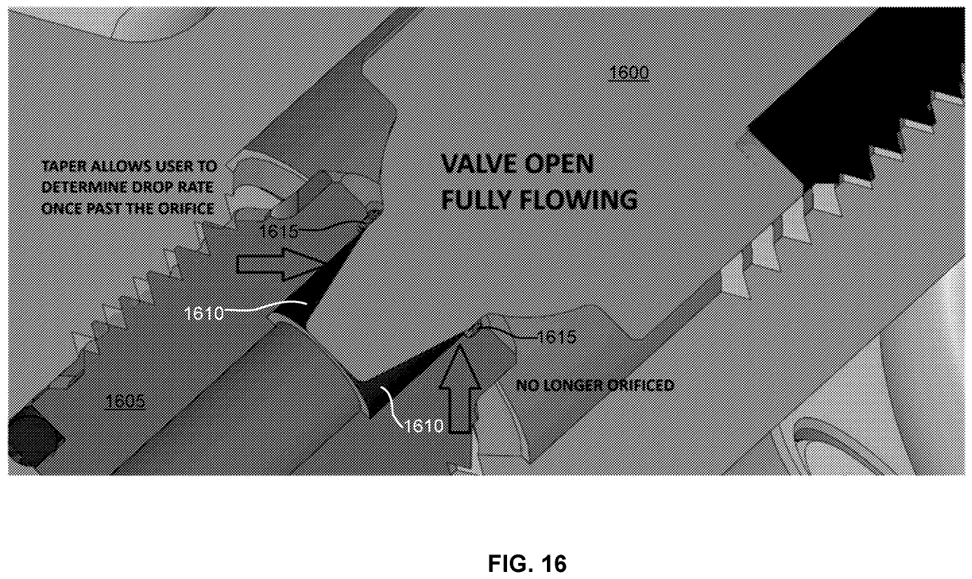

FIG. 16 shows an example of a hydraulic valve open and allowing a full flow of hydraulic fluid according to aspects of the present disclosure. The example shown includes plunger 1600 and valve seat 1605. In some embodiments, valve seat 1605 includes orifice region 1610 and shoulder region 1615.

Plunger 1600 is an example of, or includes aspects of, the corresponding element described with reference to FIGS. 5-7, 10-15, and 17. Valve seat 1605 is an example of, or includes aspects of, the corresponding element described with reference to FIGS. 5, 7, 10-15, and 17. Orifice region 1610 is an example of, or includes aspects of, the corresponding element described with reference to FIGS. 6, 7, and 10-15. Shoulder region 1615 is an example of, or includes aspects of, the corresponding element described with reference to FIGS. 6, 7, 14, and 15.

In the present disclosure, especially in FIGS. 7-16, an apparatus, system, and method for high performance jacks and hydraulic valves is described. One or more embodiments of the apparatus, system, and method include a hydraulic valve comprising a valve housing; a valve seat comprising an orifice region having a constant width of a first orifice width; and a plunger comprising a first plunger region and a second plunger region configured to be inserted into the orifice region of the valve seat, wherein the first plunger region extends in an axial direction from an end of the plunger and comprises an increasing width from a first plunger width at the end of the plunger to a second plunger width less than the first orifice width, and wherein the second plunger region is adjacent to the first plunger region and extends in the axial direction with a constant width of the second plunger width.

In some embodiments, the plunger further comprises a third plunger region and a fourth plunger region, wherein the third plunger region is adjacent to the second plunger region and extends in the axial direction with an increasing width from the second plunger width to a third plunger width that is greater than the first orifice width, and wherein the fourth plunger region is adjacent to the third plunger region and extends in the axial direction with a constant width of a fourth plunger width greater than the third plunger width.

In some embodiments, the valve seat comprises a shoulder region adjacent to the orifice region and extending in the axial direction, wherein the shoulder region comprises an increasing width from the first orifice width to a second orifice width greater than the first orifice width.

Some examples of the apparatus, system, and method further include an inflow channel configured to allow hydraulic fluid to flow through the valve seat into the orifice region.

Some examples of the apparatus, system, and method further include an outflow channel configured to allow hydraulic fluid to flow out of the valve housing.

In some examples of the apparatus, system, and method, the hydraulic valve is disposed in a floor jack. In some examples of the apparatus, system, and method, the hydraulic valve is disposed in a bottle jack. In some examples, the hydraulic valve is disposed in a high lift jack, a scissor lift (or scissor lift table), or a combination thereof.

### Jack Configured for Multi-Stage Load-Arm Lowering

FIG. 17 shows an example of a jack 1700 including a non-linear valve according to aspects of the present disclosure. In some embodiments, jack 1700 includes base 1705, handle 1710, load arm 1715, and hydraulic valve 1720. Hydraulic valve 1720 is controllable by the handle 1710 to lower the load arm 1715 of the jack 1700. In a first range of positions of the handle 1710, the hydraulic valve 1720 is configured to enable the load arm 1715 to be lowered at an increasing rate with respect to a change in a position of the handle 1710; in a second range of positions of the handle 1710, the hydraulic valve 1720 is configured to enable the load arm 1715 to be lowered at a constant rate with respect to the change in a position of the handle 1710; and in a third range of positions of the handle 1710, the hydraulic valve 1720 is configured to enable the load arm 1715 to be lowered at an increasing rate with respect to the change in a position of the handle 1710. See more details described referring to FIG. 21.

In some embodiments, The increasing rate corresponding to the first range of positions of the handle 1710 and the increasing rate corresponding to the third range of positions of the handle 1710 can be same or different. Hydraulic valve 1720 is configured to enable the load arm 1715 to be lowered with no load on the load arm 1715.

The specific example as depicted in FIG. 17 comprises a floor jack, but the scope of the present disclosure is not limited to the specific example or to floor jacks. In various embodiments, jack 1700 comprises a floor jack, a bottle jack, a hydraulic high lift jack, or a hydraulic scissor lift table, or a combination thereof. The term “load arm” can be interpreted as a load connected to the apparatus configured to be lowered, for example by a pad that is not arm-shaped, the pad configured to receive a load.

The example depicted in jack 1700 is an example of or includes aspects of corresponding elements described with FIGS. 1-3. Base 1705 is an example of, or includes aspects of, the corresponding element described with reference to FIGS. 1-3. Handle 1710 is an example of, or includes aspects of, the corresponding element described with reference to FIGS. 1-3. Load arm 1715 is an example of, or includes aspects of, the corresponding element described with reference to FIGS. 1-3.

In some embodiments, hydraulic valve 1720 includes inflow channel 1725, valve housing 1730, valve seat 1735, plunger 1740. Hydraulic valve 1720 is an example of, or includes aspects of, the corresponding element described with reference to FIGS. 5-7.

Inflow channel 1725 is an example of, or includes aspects of, the corresponding element described with reference to FIGS. 5-7. Valve housing 1730 is an example of, or includes aspects of, the corresponding element described with reference to FIGS. 5, 6, and 9. Valve seat 1735 is an example of, or includes aspects of, the corresponding element described with reference to FIGS. 5, 7, and 10-16. Plunger 1740 is an example of, or includes aspects of, the corresponding element described with reference to FIGS. 5-7, and 10-16.

With the design as disclosed herein, when there is little or no load on the load arm 1715, the handle 1710 can be opened slightly further than normal to generate a quick rate of drop or lowering. When there is a load, the orifice (e.g. orifice region 715 and/or the shoulder region 725 described with reference to FIG. 7) is configured to slow down the fall speed (rate of lowering the load arm 1715), where the orifice size (e.g. widths or other aspects of sizes for the orifice region 715 and/or the shoulder region 725) in the valve (e.g. hydraulic valve 1720) can be sized properly for the expected load and suitable/desired fall speed (rate of lowering).

In alternative or additional embodiments, the pressure generated by the load in the system (e.g. load on the load arm 1715) is used to apply force to change the size of the orifice (e.g. widths or other aspects of sizes for the orifice region 715 and/or the shoulder region 725), where more pressure generates lower fluid flow and absence of pressure generates normal full flow conditions.

In alternative or additional embodiments, a secondary pressure-controlled valve (e.g. an additional hydraulic valve) upstream or downstream of a pressure relief valve (e.g. hydraulic valve 700 or hydraulic valve 1720) is used to reduce flow, where a combination of the pressure relief valve and the secondary pressure-controlled valve is used to create a suitable/desired orifice under various conditions. That is, the additional hydraulic valve downstream of the hydraulic valve (e.g. hydraulic valve 1720) with respect to hydraulic fluid (or its flow), where the additional hydraulic valve is configured to decrease a rate of the hydraulic fluid, e.g. based on a pressure difference.

For example, a pressure difference between the upstream and downstream sides of the valve causes it to move, restricting the flow. The idea is that when the main valve (ball and seat) opens, the downstream pressure of the orifice valve drops and the upstream pressure takes time to react. During that time, the pressure difference between the left and right sides pushes the valve plunger to the right. As it moves right, the orifice that allows pressure equalization reduces, decreasing the flow. When there is no pressure difference (or “delta P”) across the valve such as when there is no load on the pad, the spring-held valve plunger does nothing and allows the pad to drop normally. As the load increases, the drop rate increases because the valve plunger increasingly restricts or “orifices” the flow. If a spring or other component fails, protection should be implemented to prevent an unexpected, rapid drop for the user.

If a high-pressure check valve fails due to debris on its seat, and a secondary valve with a high cracking pressure is in line to the reservoir, the flow is similarly orificed. In such cases, 7000 psi in the system is allowed to barely escape through the first valve. It then hits the second check valve, which has a cracking pressure near 100 psi to open. This setup acts as a pair of in-line orifices and creates a slow drop rate. When these operations occur normally or recurrently, they create a two-stage release valve. This valve allows full flow through the two valves before opening a secondary port that also allows full flow.

In alternative or additional embodiments, an electronically controlled fail-closed type valve can be used e.g. as an alternative, addition, example or other aspect of hydraulic valve 1720, which runs a parallel fluid path to a primary drop and is configured to be activated on a push of a button. Though operated electrically, closer and easier control of the flow rate may be found in such alternative or additional embodiments.

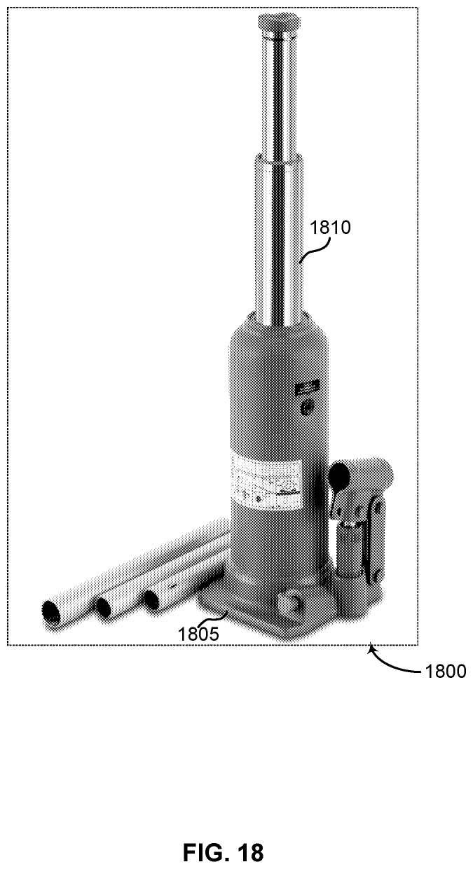

FIG. 18 shows an example of a bottle jack 1800 according to aspects of the present disclosure. In the example, bottle jack 1800 includes base 1805 and handle 1810.

Bottle jack 1800 and its components are examples of jacks according to the present disclosure. For example, a hydraulic valve as described according to the present disclosure can be disposed in bottle jack 1800. The hydraulic valve disposed in bottle jack 1800 can be an example of, or includes aspects of, hydraulic valve 700 or hydraulic valve 800 as described with reference to FIGS. 7-8.

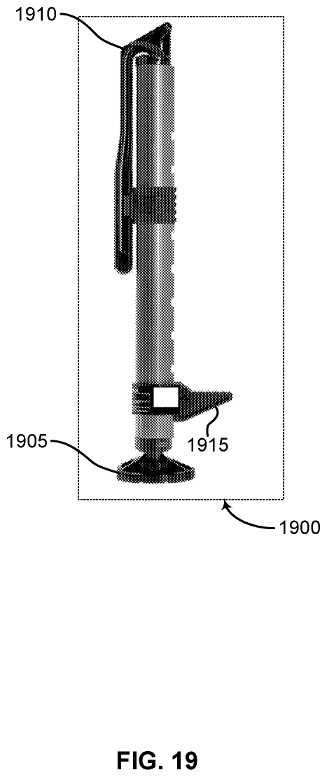

FIG. 19 shows an example of a hydraulic high lift jack 1900 according to aspects of the present disclosure. In the example, hydraulic high lift jack 1900 includes base 1905, handle 1910, and load pad 1915. Load pad 1915 is an example of, or includes aspects of, corresponding elements (e.g. load arms) described with reference to FIGS. 1-3.

Hydraulic high lift jack 1900 and its components are examples of jacks according to the present disclosure. For example, a hydraulic valve as described according to the present disclosure can be disposed in hydraulic high lift jack 1900. The hydraulic valve disposed in hydraulic high lift jack 1900 may be an example of, or includes aspects of, hydraulic valve 700 or hydraulic valve 800 as described with reference to FIGS. 7-8. In alternative or additional embodiments, hydraulic high lift jack 1900 comprises a mechanical jack.

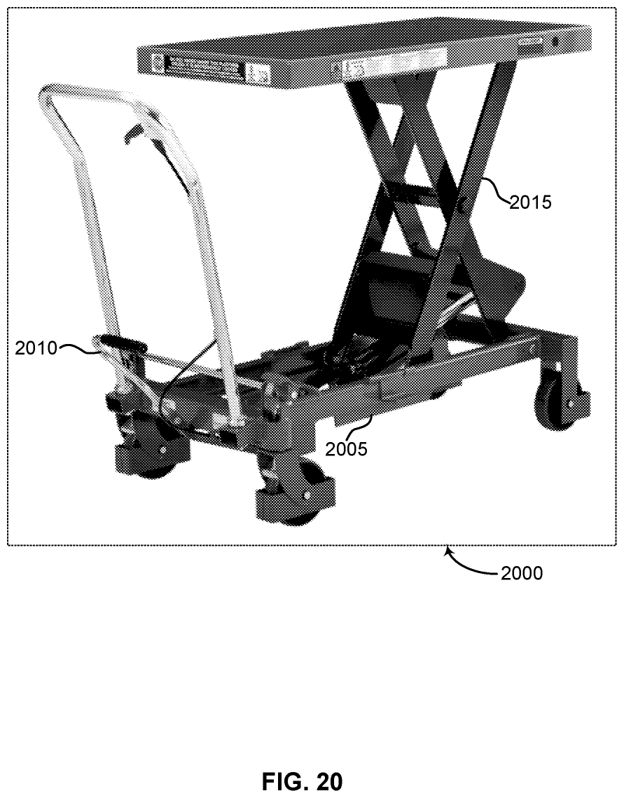

FIG. 20 shows an example of a hydraulic scissor lift table 2000 according to aspects of the present disclosure. In the example, hydraulic scissor lift table 2000 includes base 2005, handle 2010, and load arm 2015. Handle 2010 may be a rotating handle or designed otherwise e.g. to operate the hydraulic scissor lift table 2000.

Hydraulic scissor lift table 2000 and its components are examples of jacks according to the present disclosure. For example, a hydraulic valve as described according to the present disclosure can be disposed in hydraulic scissor lift table 2000. The hydraulic valve disposed in hydraulic scissor lift table 2000 can be an example of, or includes aspects of, hydraulic valve 700 or hydraulic valve 800 as described with reference to FIGS. 7-8.

FIG. 21 shows an example of a jack configured for multi-stage load-arm lowering in comparison with conventional jacks according to aspects of the present disclosure. The example shown includes load arm lowering curve for jacks according to present disclosure 2100, first range of positions of the handle 2105, first rate of load arm lowering 2110, second range of positions of the handle 2115, second rate of load arm lowering 2120, third range of positions of the handle 2125, third rate of load arm lowering 2130, and load arm lowering curve for conventional jacks 2135. The example is directed to an apparatus that comprises a floor jack, a bottle jack, a hydraulic high lift jack, or a hydraulic scissor lift table, or a combination thereof. The term “load arm” can be interpreted as a load connected to the apparatus configured to be lowered, for example by a pad that is not arm-shaped. The example includes or describes aspects of jack 1700 (see FIG. 17), or corresponding elements of FIGS. 18-20, or a combination thereof.

In FIG. 21, a rate for the load arm lowering typically corresponds to or relates to a rate of the hydraulic flow, which can be controlled e.g. by turning the handle to change the ranges of positions of the handle, as reflected or depicted by load arm lowering curve for jacks according to present disclosure 2100, improving over the load arm lowering curve for conventional jacks 2135. The load arm lowering curve for conventional jacks 2135 is typically generated by a (conventional) needle valve, the latter typically providing a more linear rate of flow increase compared to the present disclosure.

A feature of the present disclosure e.g. embodying FIG. 21 is that, within different ranges of handle positions (e.g. by user turning the handle), the load arm drops at different rates or ranges of rates, where particularly corresponding to a certain range of handle positions, the load arm drops at a constant rate or speed corresponding to a constant rate or speed of the hydraulic fluid flow. This is in some embodiments referred to as a multi-stage loading arm lowering.

For example, in some embodiments, within a first range of positions of the handle 2105, the hydraulic valve is configured to enable the load arm to be lowered at an increasing rate (first rate of load arm lowering 2110) with respect to a change in a position of the handle; within a second range of positions of the handle 2115 adjacent to the first range (first range of positions of the handle 2105), the hydraulic valve is configured to enable the load arm to be lowered at a constant rate (second rate of load arm lowering 2120, where flow rate occurs but does not increase as the valve opens; in other words, this valve's flow rate is fixed for a certain amount of handle rotation before rapidly increasing to much higher flow) with respect to the change in the position of the handle; and within a third range of positions of the handle 2125, the hydraulic valve is configured to enable the load arm to be lowered at an increasing rate (third rate of load arm lowering 2130) with respect to the change in the position of the handle. The increasing rate corresponding to the first rate of load arm lowering 2110 and the increasing rate corresponding to the third rate of load arm lowering 2130 can be a same or different. In some embodiments, thanks to the load arm lowering curve for jacks according to present disclosure 2100, the jack is configured to enable the load arm to be lowered with no load on the load arm.

Conventional jacks typically operate using a needle valve, with applications ranging from, for a non-limiting example, HARBOR FREIGHT® tools to aerospace or car racing. A needle valve typically provides a “linear” opening response as depicted by the load arm lowering curve for conventional jacks 2135. For conventional jacks, the valve typically has an orifice that dampens the needle valve's effect to flatten the linear flow rate on the graph, so as the user opens the valve, the flow rate increases with any motion of the cone/plunger. At operation of conventional jacks, the further the user opens it, the faster the fluid flows, and consequently, the faster the load drop or load arm lowers. Accordingly, the user must very carefully crack the valve off the seat to maintain a reasonable drop rate for these typical jacks, aiming to find a desired flow e.g. by trials and errors. This takes a decent amount of effort from the operator, leading to potential safety issues and diminished user experiences. In the present disclosure.

In some embodiments, as indicated by the load arm lowering curve for jacks according to present disclosure 2100, the flow rate increases to a max allowed by the orifice and then holds steady until the taper starts, and subsequently reverts to a behavior like a needle valve in the sense that the flow rate continues to increase after the “holding steady” stage. This corresponds to the three stages of the load arm lowering curve for jacks according to present disclosure 2100, read from left to the right. As such, the operator or user can open the valve as fast or slow as desired; for example, for the second range of positions of the handle 2115 (e.g. corresponding to a first 90 degrees of handle rotation) the load drops at a constant speed (second rate of load arm lowering 2120). Specific value of the drop speed (e.g. second rate of load arm lowering 2120) depends on the chosen orifice and the load on the load arm. This achieves fine-grained control of flow and drop speed, reduces safety concerns, offering an advantage over existing designs, and solving a challenging problem of achieving fine-grained flow rate and drop rate control in valve-based jacks.

In the present disclosure, especially in FIGS. 17-21, an apparatus, system, and method for high performance jacks and hydraulic valves is described. One or more embodiments of the apparatus, system, and method include a jack comprising a base; a handle; a load arm; and a hydraulic valve controllable by the handle to lower the load arm, wherein: within a first range of positions of the handle, the hydraulic valve is configured to enable the load arm to be lowered at an increasing rate with respect to a change in a position of the handle; within a second range of positions of the handle adjacent to the first range, the hydraulic valve is configured to enable the load arm to be lowered at a constant rate with respect to the change in the position of the handle; and within a third range of positions of the handle adjacent to the second range, the hydraulic valve is configured to enable the load arm to be lowered at an increasing rate with respect to the change in the position of the handle.

In some embodiments, the jack is configured to enable the load arm to be lowered with no load on the load arm.

In some examples of the apparatus, system, and method, the hydraulic valve includes a valve housing. In some examples, the hydraulic valve further includes a valve seat comprising an orifice region having a constant width of a first orifice width. In some examples, the hydraulic valve further includes a plunger comprising a first plunger region and a second plunger region configured to be inserted into the orifice region of the valve seat, wherein the first plunger region extends in an axial direction from an end of the plunger and comprises an increasing width from a first plunger width at the end of the plunger to a second plunger width less than the first orifice width, and wherein the second plunger region is adjacent to the first plunger region and extends in the axial direction with a constant width of the second plunger width.

In some embodiments, the plunger further comprises a third plunger region and a fourth plunger region, wherein the third plunger region is adjacent to the second plunger region and extends in the axial direction with an increasing width from the second plunger width to a third plunger width that is greater than the first orifice width, and wherein the fourth plunger region is adjacent to the third plunger region and extends in the axial direction with a constant width of a fourth plunger width greater than the third plunger width.

In some embodiments, the valve seat comprises a shoulder region adjacent to the orifice region and extending in the axial direction, wherein the shoulder region comprises an increasing width from the first orifice width to a second orifice width greater than the first orifice width.

Some examples of the apparatus, system, and method further include an inflow channel configured to allow hydraulic fluid to flow through the valve seat into the orifice region.

Some examples of the apparatus, system, and method further include an outflow channel configured to allow hydraulic fluid to flow out of the valve housing.

In some embodiments of the apparatus, system, and method, the jack comprises a floor jack, a bottle jack, a hydraulic high lift jack, or a hydraulic scissor lift table. In some examples, the jack comprises any combination of a floor jack, a bottle jack, a high lift jack, or a scissor lift table.

Some examples of the apparatus, system, and method further include an additional hydraulic valve downstream of the hydraulic valve with respect to hydraulic fluid, wherein the additional hydraulic valve is configured to decrease a rate of the hydraulic fluid.

In the present disclosure, especially in FIGS. 17-21, an apparatus, system, and method for high performance jacks and hydraulic valves is described. One or more embodiments of the apparatus, system, and method include a base, a handle, and a hydraulic valve controllable by the handle to lower a load, wherein: within a first range of positions of the handle, the hydraulic valve is configured to enable the load to be lowered at an increasing rate with respect to a change in a position of the handle; within a second range of positions of the handle adjacent to the first range, the hydraulic valve is configured to enable the load to be lowered at a constant rate with respect to the change in the position of the handle; and within a third range of positions of the handle adjacent to the second range, the hydraulic valve is configured to enable the load to be lowered at an increasing rate with respect to the change in the position of the handle.

In some embodiments, the apparatus is configured to enable the load to be lowered with no weight for the load. For example, the load may refer to or include aspects of a container connected to the apparatus, the container configured to receive an object (e.g. a car or a stack of documents); in the example, the load comprises no weight therefor (e.g. with no weight for the load) when the container receives no object, e.g. when no car or stack of documents is disposed in the container.

In some embodiments, the hydraulic valve comprises: a valve housing; a valve seat comprising an orifice region having a constant width of a first orifice width; and a plunger comprising a first plunger region and a second plunger region configured to be inserted into the orifice region of the valve seat, wherein the first plunger region extends in an axial direction from an end of the plunger and comprises an increasing width from a first plunger width at the end of the plunger to a second plunger width less than the first orifice width, and wherein the second plunger region is adjacent to the first plunger region and extends in the axial direction with a constant width of the second plunger width.

In some embodiments, the plunger further comprises a third plunger region and a fourth plunger region, wherein the third plunger region is adjacent to the second plunger region and extends in the axial direction with an increasing width from the second plunger width to a third plunger width that is greater than the first orifice width, and wherein the fourth plunger region is adjacent to the third plunger region and extends in the axial direction with a constant width of a fourth plunger width greater than the third plunger width.

In some embodiments, the valve seat comprises a shoulder region adjacent to the orifice region and extending in the axial direction, wherein the shoulder region comprises an increasing width from the first orifice width to a second orifice width greater than the first orifice width.

In some embodiments, the apparatus further includes an inflow channel configured to allow hydraulic fluid to flow through the valve seat into the orifice region. In some embodiments, the apparatus further includes an outflow channel configured to allow the hydraulic fluid to flow out of the valve housing.

In some embodiments, the apparatus further includes a load arm configured to support the load. In some embodiments, the apparatus further includes an additional hydraulic valve downstream of the hydraulic valve with respect to hydraulic fluid, wherein the additional hydraulic valve is configured to decrease a rate of the hydraulic fluid.

In the present disclosure, especially in FIGS. 7-21, an apparatus, system, and method for high performance jacks and hydraulic valves is described. One or more embodiments of the apparatus, system, and method include a jack comprising a base; a handle; a load arm; and a hydraulic valve comprising: a valve housing; a valve seat comprising an orifice region having a constant width of a first orifice width; and a plunger comprising a first plunger region and a second plunger region configured to be inserted into the orifice region of the valve seat, wherein the first plunger region extends in an axial direction from an end of the plunger and comprises an increasing width from a first plunger width at the end of the plunger to a second plunger width less than the first orifice width, and wherein the second plunger region is adjacent to the first plunger region and extends in the axial direction with a constant width of the second plunger width.

In some embodiments, the plunger further comprises a third plunger region and a fourth plunger region, wherein the third plunger region is adjacent to the second plunger region and extends in the axial direction with an increasing width from the second plunger width to a third plunger width that is greater than the first orifice width, and wherein the fourth plunger region is adjacent to the third plunger region and extends in the axial direction with a constant width of a fourth plunger width greater than the third plunger width.

In some embodiments, the valve seat comprises a shoulder region adjacent to the orifice region and extending in the axial direction, wherein the shoulder region comprises an increasing width from the first orifice width to a second orifice width greater than the first orifice width.

Some examples of the apparatus, system, and method further include an inflow channel configured to allow hydraulic fluid to flow through the valve seat into the orifice region.

In some embodiments of the apparatus, system, and method, the jack comprises a floor jack, a bottle jack, a hydraulic high lift jack, or a hydraulic scissor lift table. In some examples, the jack comprises any combination of a floor jack, a bottle jack, a high lift jack, or a scissor lift table.

Some examples of the apparatus, system, and method further include an outflow channel configured to allow hydraulic fluid to flow out of the valve housing.

In some examples of the apparatus, system, and method, within a first range of positions of the handle, the hydraulic valve is configured to enable the load arm to be lowered at an increasing rate with respect to a change in a position of the handle. Some examples further include within a second range of positions of the handle adjacent to the first range, the hydraulic valve is configured to enable the load arm to be lowered at a constant rate with respect to the change in the position of the handle. Some examples further include within a third range of positions of the handle adjacent to the second range, the hydraulic valve is configured to enable the load arm to be lowered at an increasing rate with respect to the change in the position of the handle.

In some embodiments, the jack is configured to enable the load arm to be lowered with no load on the load arm.

The description and drawings described herein represent example configurations and do not represent all the implementations within the scope of the claims. For example, the operations and steps may be rearranged, combined or otherwise modified. Also, structures and devices may be represented in the form of block diagrams to represent the relationship between components and avoid obscuring the described concepts. Similar components or features may have the same name but may have different reference numbers corresponding to different figures.

Some modifications to the disclosure may be readily apparent to those skilled in the art, and the principles defined herein may be applied to other variations without departing from the scope of the disclosure. Thus, the disclosure is not limited to the examples and designs described herein, but is to be accorded the broadest scope consistent with the principles and novel features disclosed herein.

The described methods may be implemented or performed by devices that include a general-purpose processor, a digital signal processor (DSP), an application specific integrated circuit (ASIC), a field programmable gate array (FPGA) or other programmable logic device, discrete gate or transistor logic, discrete hardware components, or any combination thereof. A general-purpose processor may be a microprocessor, a conventional processor, controller, microcontroller, or state machine. A processor may also be implemented as a combination of computing devices (e.g., a combination of a DSP and a microprocessor, multiple microprocessors, one or more microprocessors in conjunction with a DSP core, or any other such configuration). Thus, the operations described herein such as turning the handle or opening the valve may be implemented in hardware or software and may be executed by a processor, firmware, or any combination thereof. If implemented in software executed by a processor, the functions may be stored in the form of instructions or code on a computer-readable medium.

In this disclosure and the following claims, the word “or” indicates an inclusive list such that, for example, the list of X, Y, or Z means X or Y or Z or XY or XZ or YZ or XYZ. Also the phrase “based on” is not used to represent a closed set of conditions. For example, a step that is described as “based on condition A” may be based on both condition A and condition B. In other words, the phrase “based on” shall be construed to mean “based at least in part on.” Also, the words “a” or “an” indicate “at least one.”

What is claimed is:

1. A hydraulic valve comprising:
a valve housing;
a valve seat comprising an orifice region having a constant width of a first orifice width; and
a plunger comprising a first plunger region and a second plunger region configured to be inserted into the orifice region of the valve seat, wherein the first plunger region extends in an axial direction from an end of the plunger and comprises an increasing width from a first plunger width at the end of the plunger to a second plunger width less than the first orifice width, and wherein the second plunger region is adjacent to the first plunger region and extends in the axial direction with a constant width of the second plunger width.

2. The hydraulic valve of claim 1, wherein:
the plunger further comprises a third plunger region and a fourth plunger region, wherein the third plunger region is adjacent to the second plunger region and extends in the axial direction with an increasing width from the second plunger width to a third plunger width that is greater than the first orifice width, and wherein the fourth plunger region is adjacent to the third plunger region and extends in the axial direction with a constant width of a fourth plunger width greater than the third plunger width.

3. The hydraulic valve of claim 1, wherein:
the valve seat comprises a shoulder region adjacent to the orifice region and extending in the axial direction, wherein the shoulder region comprises an increasing width from the first orifice width to a second orifice width greater than the first orifice width.

4. The hydraulic valve of claim 1, wherein:
the hydraulic valve is disposed in a floor jack.

5. The hydraulic valve of claim 1, wherein:
the hydraulic valve is disposed in a bottle jack.

6. A jack comprising:
a base;
a handle;
a load arm; and
a hydraulic valve comprising:
a valve housing;
a valve seat comprising an orifice region having a constant width of a first orifice width; and
a plunger comprising a first plunger region and a second plunger region configured to be inserted into the orifice region of the valve seat, wherein the first plunger region extends in an axial direction from an end of the plunger and comprises an increasing width from a first plunger width at the end of the plunger to a second plunger width less than the first orifice width, and wherein the second plunger region is adjacent to the first plunger region and extends in the axial direction with a constant width of the second plunger width.

7. The jack of claim 6, wherein:
the plunger further comprises a third plunger region and a fourth plunger region, wherein the third plunger region is adjacent to the second plunger region and extends in the axial direction with an increasing width from the second plunger width to a third plunger width that is greater than the first orifice width, and wherein the fourth plunger region is adjacent to the third plunger region and extends in the axial direction with a constant width of a fourth plunger width greater than the third plunger width.

8. The jack of claim 6, wherein:
the valve seat comprises a shoulder region adjacent to the orifice region and extending in the axial direction, wherein the shoulder region comprises an increasing width from the first orifice width to a second orifice width greater than the first orifice width.

9. The jack of claim 6, further comprising:
an inflow channel configured to allow hydraulic fluid to flow through the valve seat into the orifice region; and
an outflow channel configured to allow the hydraulic fluid to flow out of the valve housing.

10. The jack of claim 6, wherein:
the jack comprises a floor jack, a bottle jack, a hydraulic high lift jack, or a hydraulic scissor lift table.

11. The jack of claim 6, wherein:
within a first range of positions of the handle, the hydraulic valve is configured to enable the load arm to be lowered at an increasing rate with respect to a change in a position of the handle;
within a second range of positions of the handle adjacent to the first range, the hydraulic valve is configured to enable the load arm to be lowered at a constant rate with respect to the change in the position of the handle; and
within a third range of positions of the handle adjacent to the second range, the hydraulic valve is configured to enable the load arm to be lowered at an increasing rate with respect to the change in the position of the handle.

12. The jack of claim 6, wherein:
the jack is configured to enable the load arm to be lowered with no load on the load arm.

13. An apparatus comprising:
a base;
a handle; and
a hydraulic valve controllable by the handle to lower a load, wherein:
within a first range of positions of the handle, the hydraulic valve is configured to enable the load to be lowered at an increasing rate with respect to a change in a position of the handle;
within a second range of positions of the handle adjacent to the first range, the hydraulic valve is configured to enable the load to be lowered at a constant rate with respect to the change in the position of the handle; and
within a third range of positions of the handle adjacent to the second range, the hydraulic valve is configured to enable the load to be lowered at an increasing rate with respect to the change in the position of the handle.

14. The apparatus of claim 13, wherein:
the apparatus is configured to enable the load to be lowered with no weight for the load.

15. The apparatus of claim 13, wherein the hydraulic valve comprises:
a valve housing;
a valve seat comprising an orifice region having a constant width of a first orifice width; and
a plunger comprising a first plunger region and a second plunger region configured to be inserted into the orifice region of the valve seat, wherein the first plunger region extends in an axial direction from an end of the plunger and comprises an increasing width from a first plunger width at the end of the plunger to a second plunger width less than the first orifice width, and wherein the second plunger region is adjacent to the first plunger region and extends in the axial direction with a constant width of the second plunger width.

16. The apparatus of claim 15, wherein:
the plunger further comprises a third plunger region and a fourth plunger region, wherein the third plunger region is adjacent to the second plunger region and extends in the axial direction with an increasing width from the second plunger width to a third plunger width that is greater than the first orifice width, and wherein the fourth plunger region is adjacent to the third plunger region and extends in the axial direction with a constant width of a fourth plunger width greater than the third plunger width.

17. The apparatus of claim 15, wherein:
the valve seat comprises a shoulder region adjacent to the orifice region and extending in the axial direction, wherein the shoulder region comprises an increasing width from the first orifice width to a second orifice width greater than the first orifice width.

18. The apparatus of claim 15, further comprising:
an inflow channel configured to allow hydraulic fluid to flow through the valve seat into the orifice region; and
an outflow channel configured to allow the hydraulic fluid to flow out of the valve housing.

19. The apparatus of claim 15, further comprising:
a load arm configured to support the load.

20. The apparatus of claim 13, further comprising:
an additional hydraulic valve downstream of the hydraulic valve with respect to hydraulic fluid, wherein the additional hydraulic valve is configured to decrease a rate of the hydraulic fluid.
